(19) United States
(12) Patent Application Publication
(10) Pub. No.: US 2026/0332424 A1
(43) Pub. Date: Oct. 22, 2026

(54) CONTROL PLANE ARCHITECTURE AND CRYPTOGRAPHIC AUTHENTICATION OF ARTIFICIAL INTELLIGENCE PROCESSES

(71) Applicant: Quiet Signal Technologies LLC, Flowood, MS (US)

(72) Inventor: Jennifer Joiner Bryan, Brandon, MS (US)

(21) Appl. No.: 19/654,941

(22) Filed: Apr. 22, 2026

Related U.S. Application Data
(63) Continuation-in-part of application No. 19/185,913, filed on Apr. 22, 2025.
(63) Continuation-in-part of application No. 19/190,458, filed on Apr. 25, 2025.

(51) Int. Cl. H04L 9/32; G06F 21/62

(52) U.S. Cl. CPC H04L 9/3234; G06F 21/6254

(57) ABSTRACT

Examples provide a process including receiving input including first data associated with a request to invoke at least one downstream AI process and a credential token associated with an upstream component, and performing a check with respect to at least the first data responsive to determining that the credential token authorizes invocation of the at least one downstream AI process. The process includes outputting at least one signal selectively authorizing the at least one downstream AI process to be executed, requesting user review of the request, or blocking execution of the at least one downstream AI process based on a result of the check. The process includes generating a cryptographically verifiable record.

### CROSS-REFERENCE TO RELATED APPLICATIONS

This Application is a continuation-in-part of U.S. application Ser. No. 19/190,458, filed on Apr. 25, 2025, entitled “System and Method for Credential-Governed Invocation and Fallback Governance of Artificial Intelligence Symbolic Outputs,” and U.S. application Ser. No. 19/185,913, filed on Apr. 22, 2025, entitled “Orchestrix Integrated Clinical Ai Orchestration System,” the entire disclosures of which are incorporated herein by reference.

### TECHNICAL FIELD

The present disclosure relates to artificial intelligence systems, and more specifically, to cryptographic authentication and authorization in artificial intelligence systems.

### BACKGROUND

Artificial intelligence (AI) systems are increasingly deployed across a variety of industries to generate outputs including text, structured data, documentation, annotations, decisions, and/or other machine-generated artifacts. Such outputs may be transmitted, rendered, exported, or incorporated into downstream systems and workflows.

### SUMMARY

Conventional approaches to AI governance and oversight rely on retrospective monitoring, internal logging, or manual audit processes that record AI activity after execution has already occurred. These conventional approaches do not structurally condition execution of an AI process on authentication of a credential associated with the invoking entity, nor do conventional approaches generate a cryptographically verifiable record of authorized AI execution that can be independently authenticated by downstream systems or other third parties. As a result, conventional AI governance systems lack the ability to prevent unauthorized invocation of AI processes prior to execution, cannot bind each AI-assisted decision to a verified credential holder, and do not produce portable evidence artifacts that travel with the output and can be verified without access to the originating infrastructure. Furthermore, conventional systems do not detect when an AI-generated output appears without an expected authorization record, leaving gaps in accountability and traceability.

Furthermore, conventional AI governance systems lack adequate mechanisms for detecting and removing personally identifying information (PII) from AI-generated outputs and associated governance records prior to storage, export, or transmission to downstream systems. In conventional approaches, sensitive data such as user identifiers, user credentials, location-specific information, and other protected attributes may persist in internal logs, audit trails, or exported artifacts without systematic scrubbing or anonymization, thereby increasing the risk of unauthorized disclosure and non-compliance with applicable privacy regulations. Additionally, conventional systems do not enforce cryptographic binding between credential tokens and governance records in a manner that prevents tampering, replay, or unauthorized reuse of credential artifacts, nor do conventional systems implement automated credential expiration, revocation propagation, or inactivity-based credential invalidation to limit the window of exposure when credentials are compromised. As a result, conventional AI governance architectures are vulnerable to credential misuse, unauthorized access to AI processes through stale or compromised tokens, and inadvertent exposure of PII across the AI execution lifecycle, particularly in regulated industries where privacy and data security requirements are stringent.

As the foregoing illustrates, there is a need for computational systems and methods that condition execution of AI processes on credential-based authorization, generate cryptographically verifiable records of authorized AI execution, detect omission of expected authorization records, and produce portable audit packages enabling independent third-party verification. One example provides a process including receiving, from an upstream component, input including first data associated with a request to invoke at least one downstream AI process and a credential token associated with the upstream component, determining whether the credential token authorizes invocation of the at least one downstream AI process, and performing a check with respect to at least the first data responsive to determining that the credential token authorizes invocation of the at least one downstream AI process. The process includes, based on a result of the check, outputting at least one signal selectively authorizing the at least one downstream AI process to be executed, requesting user review of the request, or blocking execution of the at least one downstream AI process. The process includes generating a cryptographically verifiable governance record including at least one of the credential token, at least a portion of the first data, an identifier of the at least one downstream AI process, a confidence level associated with the check, a result of the check, a timestamp, an output of the at least one AI process, or a combination thereof.

In some aspects, the process includes, responsive to determining that the credential token does not authorize invocation of the AI process, blocking an invocation of the at least one AI process.

In some aspects, outputting at least one signal requesting user review of the request or blocking execution of the at least one downstream AI process is performed responsive to a plausibility metric being below a threshold.

In some aspects, outputting at least one signal authorizing the at least one downstream AI process to be executed is performed responsive to a plausibility metric meeting or exceeding a threshold.

In some aspects, the check includes analyzing semantic consistency of the first data, behavioral deviation associated with the first data, statistical abnormality of the first data relative to at least one historical baseline, or a combination thereof.

In some aspects, data included in the governance record is cryptographically encoded.

In some aspects, recording the governance record includes detecting and scrubbing PII from the first data.

In some aspects, the check includes a verification of an identity of a user requesting the at least one downstream AI process based at least in part on the credential token.

In some aspects, the first data includes a structured data item, and the check includes verifying that a frequency at which the structured data item is received over a predetermined period of time is within an expected range.

In some aspects, the expected range is associated with a particular user and/or a particular facility.

In some aspects, the first data includes an unstructured data item, and the check includes verifying that the first data is semantically consistent with data included in previously received requests associated with the credential token.

In some aspects, the check is performed using a machine learning model, and the process further includes: responsive to outputting at least one signal requesting user review of the request, receiving a response indicating one of an approval of the request, a correction of the first data, or a denial of the request, and training the machine learning model based on the response.

In some aspects, the process includes updating the governance record with at least a portion of the response.

In some aspects, the credential token is a timestamped cryptographic token indicative of a particular user account.

In some aspects, the cryptographic token is further indicative of a particular location and/or a particular user role.

In some aspects, the process includes destroying the credential token responsive to recording the governance record.

In some aspects, the at least one downstream AI process includes one or more of a single-model AI process, a multi-agent AI process, a cascading agent invocation, an agent-created subordinate agent process, or a tool-assisted generation process.

Another example provides a computing system including: a memory storing instructions, and at least one processor designed to execute the instructions to cause the computing system to receive, from an upstream component, input including first data associated with a request to invoke at least one downstream AI process and a credential token associated with the upstream component, determine whether the credential token authorizes invocation of the at least one downstream AI process, and perform a check with respect to at least the first data responsive to determining that the credential token authorizes invocation of the at least one downstream AI process. The instructions cause the computing system to, based on a result of the check, output at least one signal selectively authorizing the at least one downstream AI process to be executed, requesting user review of the request, or blocking execution of the at least one downstream AI process, and record, in an on-chain ledger, a governance record associated with the request, the governance record including at least one of the credential token, at least a portion of the first data, an identifier of the at least one downstream AI process, a confidence level associated with the check, a result of the check, a timestamp, an output of the at least one AI process, or a combination thereof.

In some aspects, the instructions further cause the computing system to: responsive to determining that the credential token does not authorize invocation of the AI process, block an invocation of the at least one AI process.

Another example provides a non-transitory computer-readable medium storing instructions that, when executed by at least one processor, cause the at least one processor to perform a set of operations including: receiving, from an upstream component, input including first data associated with a request to invoke at least one downstream AI process and a credential token associated with the upstream component, determining whether the credential token authorizes invocation of the at least one downstream AI process, responsive to determining that the credential token authorizes invocation of the at least one downstream AI process, performing a check with respect to at least the first data, based on a result of the check, outputting at least one signal selectively authorizing the at least one downstream AI process to be executed, requesting user review of the request, or blocking execution of the at least one downstream AI process, generating a cryptographically signed governance record associated with the request, the governance record including at least one of the credential token, at least a portion of the first data, an identifier of the at least one downstream AI process, a confidence level associated with the check, a result of the check, a timestamp, an output of the at least one AI process, or a combination thereof, and exporting the cryptographically signed governance record.

Other aspects will become apparent by consideration of the detailed description and accompanying drawings.

When compared to conventional approaches described herein in which AI governance relies on retrospective logging or manual audit processes that record AI activity after execution has already occurred, with the disclosed techniques, an AI authorization service operates as a control plane that governs AI execution before the AI execution occurs. In this manner, AI processes cannot execute unless a credential token authorizes the invocation, and responsive to authorized execution, the AI authorization service generates a cryptographically signed governance record that can be independently verified by downstream systems, auditors, or regulators without access to the originating infrastructure. In that regard, at least one technical advantage of the disclosed techniques relative to conventional approaches is that, with the disclosed techniques, each AI-assisted decision is bound to a verified credential holder, and a governance record recorded in an on-chain ledger provides post-hoc attribution of responsibility, enabling traceable accountability across multi-actor environments.

At least another technical advantage of the disclosed techniques relative to conventional approaches is that, with the disclosed techniques, the AI authorization service can detect when an AI-generated output appears without an expected authorization record, thereby identifying gaps in the authorization chain that conventional logging-based approaches cannot detect. In that regard, because the disclosed techniques allow for detection of omission of expected authorization records and generation of portable audit packages that travel with the AI-generated output, the risk of unauthorized AI activity, fragmented accountability, and undetectable removal of authorization evidence is reduced.

### BRIEF DESCRIPTION OF THE DRAWINGS

FIG. 1 illustrates an example computing system, according to at least one embodiment.

FIG. 2 is a block diagram of example components of the AI authorization service, according to at least one embodiment.

FIG. 3 illustrates an example process for AI governance using the AI authorization service, according to at least one embodiment.

FIG. 4 illustrates an example process for performing receipt omission detection with respect to AI-generated outputs, according to at least one embodiment.

FIG. 5 is a block diagram of the system computing device that may be implemented in conjunction with the computing system of FIG. 1, according to at least one embodiment.

FIG. 6 is a swimlane diagram for an authentication workflow in which an authenticated credential for AI invocation is not detected, according to at least one embodiment.

FIG. 7 is a swimlane diagram for an authentication workflow, according to at least one embodiment.

FIG. 8 is a swimlane diagram for an authentication workflow, according to at least one embodiment.

FIGS. 9A-9D illustrate portions of an example governance receipt that may be generated in conjunction with the computing system 100, according to at least one embodiment.

FIG. 10 is a flowchart of a process for performing authentication of AI processes, according to at least one embodiment.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing details that are pertinent to understanding the examples of the present disclosure so as not to obscure the disclosure with details that will be readily apparent to those of ordinary skill in the art having the benefit of the description herein.

### DETAILED DESCRIPTION

Examples are herein described with reference to flowchart illustrations and/or block diagrams of methods, apparatus (systems) and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a special-purpose computer, or other programmable data processing apparatus to produce a special-purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence as shown and likewise various blocks may be performed in parallel rather than in sequence.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer-implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the figures.

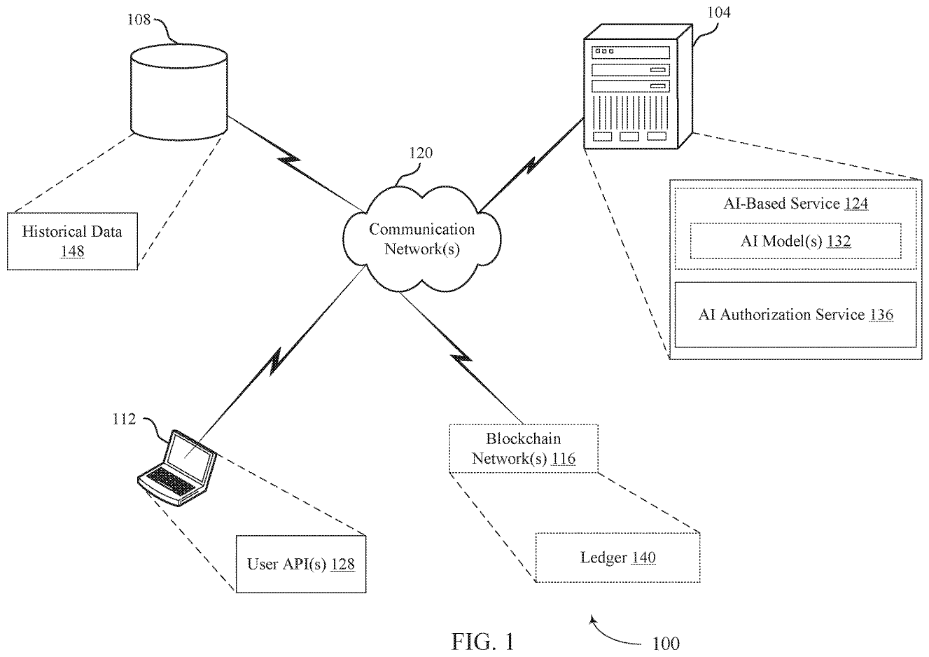

FIG. 1 illustrates an example computing system 100, according to the present teachings. As shown, the computing system 100 includes at least one system computing device 104, at least one database 108, at least one user computing device 112, and at least one blockchain network 116 communicatively connected to one another over at least one communications network 120.

The system computing device 104 and/or user computing device 112 can include any type of computing device, such as classical computing devices, such as a desktop computer, laptop, mobile phone, smartphone, tablet, netbook, database, personal digital assistant (PDA), wearable device (e.g., smartwatch, smart glasses, fitness tracker, etc.), personal computer, virtual reality or augmented reality headset, Internet of Things (IoT) device, embedded system, smart speaker, smart home controller, digital camera, media player, e-reader, point-of-sale terminal, automated teller machine (ATM), industrial control system, database server, thin client, zero client, edge computing device, a workstation, network-attached storage (NAS) device, storage area network (SAN) component, a mainframe computer, a supercomputer, computing cluster, a server (e.g., rack server, blade server, tower server, microserver, etc.), or other electronic device. The computing devices 104 and/or 112 can include classical computing devices or quantum computing devices. The computing devices 104 and/or 112 can be enabled with Internet or other network access and can be locatable by the communications network 120. In one aspect, the computing devices 104 and/or 112 can be configured to transmit or otherwise output instructions to control various devices, receive data or other signals from external devices, and transmit or otherwise output the received data or other data to the communications network 120, the at least one database 108, the blockchain network 116, a server, or another remote computing device (e.g., another database) of the computing system 100.

The at least one system computing device 104 can include an artificial intelligence (AI)-based service 124 designed to receive and process AI-based requests, such as AI-based requests initiated by the user computing device 112 via one or more user application programming interfaces (APIs) 128. In some examples, the AI-based service 124 is a network-level AI-based service 124 that processes AI-based actions from user computing devices 112 associated with a variety of different sites, departments, or facilities in an enterprise organization.

The at least one system computing device 104 can include an AI authorization service 136 designed to enforce credentialed invocation of AI processes, detect anomalous requests, and record analytic events in a ledger 140 of the blockchain network 116. In that regard, the AI authorization service 136 can be invoked by an upstream component, such as the AI-based service 124 or a software component of the at least one user computing device 112. The AI authorization service 136 can selectively authorize or block invocation of downstream AI models (e.g., the AI models 132 of the AI-based service 124 and/or an AI model 144 of the AI authorization service 136) based on a detected presence or absence of an authenticated credential received from the invoking entity. For example, the credential can include a timestamped cryptographic token bound to an invoking actor. The credential token can encode one or more of a user identifier, a user role, a facility identifier, a jurisdictional or policy context, a validity period, or combinations thereof.

In some examples, the credential token can include, or can be embodied as, any authorization datum sufficient to establish validated authority for invocation of a downstream AI process. For example, the credential token can include a signed request envelope, a session-bound capability, an account-bound entitlement object, a hardware attestation, a mutual-authenticated identity, a policy-bearing credential, an identity assertion, a cryptographic proof of authority, or an equivalent authorization datum, or a combination thereof. In this manner, the AI authorization service 136 can accept and validate diverse authority representations without requiring a single credential format, enabling interoperability across heterogeneous credentialing environments.

In some examples, the AI authorization service 136 can operate as a control plane that governs when and how AI execution of the AI-based service 124 is authorized and recorded. In that regard, the AI authorization service 136 can introduce a pre-execution control point that determines whether AI execution is permitted at all, rather than merely auditing or logging AI activity after execution has already occurred. For example, in at least one embodiment, AI systems operating within the AI-based service 124 cannot execute unless the AI authorization service 136 determines that a credential token authorizes the invocation. In this manner, the AI authorization service 136 can govern AI execution before the AI execution occurs, and can generate a cryptographically verifiable record of the authorized execution responsive to the AI execution being permitted. This pre-execution authorization architecture can distinguish the AI authorization service 136 from conventional governance approaches that focus on retrospective monitoring, post-hoc logging, and/or after-the-fact audit of AI activity.

In some examples, the AI authorization service 136 can operate as a governance layer interposed between an upstream component and one or more downstream AI processes, such that invocation of a downstream AI process occurs only responsive to a governance output of the AI authorization service 136. In this manner, the AI authorization service 136 can function as a structurally distinct control plane that mediates between the upstream component and the downstream AI process, rather than operating as an in-application authorization or logging module embedded within the downstream AI process. The architectural separation can enable the AI authorization service 136 to condition downstream AI execution on validated authority, perform pre-invocation governance evaluation, and issue a governance artifact that is bound to the governed execution, such that the downstream AI process cannot execute independently of the governance output of the AI authorization service 136.

In some examples, the authorization conferred by the credential token can apply not only to the downstream AI process initially requested, but also to chained, delegated, derived, recursively spawned, and/or tool-mediated downstream acts undertaken pursuant to the governed invocation. For example, when a governed invocation of a first downstream AI process causes the first downstream AI process to invoke a second downstream AI process, delegate execution to a subordinate agent, spawn a recursive sub-process, or invoke an external tool, the AI authorization service 136 can extend governance coverage to each such downstream act. In some examples, the AI authorization service 136 can generate a governance record for each chained, delegated, derived, recursively spawned, and/or tool-mediated downstream act, and can bind each such governance record to the originating governed invocation. In this manner, the AI authorization service 136 can reduce the risk that downstream agentic behavior occurring beyond the initially requested AI process falls outside the scope of governance coverage.

In some examples, the credential token can include a cryptographically bound hash that encapsulates an endpoint identifier, a credential tier identifier, override or fallback trace data, an authorship fingerprint, and/or a session policy reference. The cryptographically bound hash can enable detection of tampering with the credential token data and can enable verification of the contents of the credential token as a single integrity-checked payload.

In some examples, the credential token can include a policy-configurable time-to-live (TTL) setting that defines an expiration lifespan for the credential token and/or for invocation artifacts generated in association with the credential token. The TTL setting can govern how long the credential token and/or associated invocation artifacts remain valid or are retained in storage, enabling alignment with data retention policies and reducing long-term storage of sensitive invocation records that are no longer needed. The AI authorization service 136 can enforce configurable TTL intervals for governance records, invocation artifacts, and/or credential tokens, such that the AI authorization service 136 suppresses further invocation or export of outputs associated with an expired artifact.

In some examples, the AI authorization service 136 can enforce credential inactivity-based expiration such that invocation credentials expire upon lapse of use, credential inactivity, trace validation failure, or after a defined maximum interval from issuance without reaffirmed activity by the credential holder. For example, the maximum interval can be a configurable period not exceeding thirty-six (36) calendar months from issuance. Credential expiration events can trigger automated suppression of invocation rights associated with the expired credential until re-credentialing occurs.

The credential token can be received by the AI authorization service 136 as part of a request transmitted from the upstream component over the communications network 120, for example, as a digitally signed payload accompanying input data associated with a requested action. By way of example, the input data can include structured data items such as codes, action identifiers, account identifiers, or classification codes, unstructured data items such as narrative text, free-text descriptions, supporting documentation, or natural language annotations, identifiers, descriptions, procedure or service descriptions, and/or other domain-specific data associated with the requested operation.

In some examples, the credential token is issued by a credential registry or identity provider and is cryptographically signed using classical or post-quantum cryptographic algorithms to better ensure authenticity and tamper resistance. The AI authorization service 136 can operate on the credential token by, for example, verifying the cryptographic signature and validity period of the token, and determining whether the role, facility, and/or jurisdictional attributes encoded in the token authorize invocation of a requested AI model 132 of the AI-based service 124 and/or AI model 144 of the AI authorization service 136 for a particular action type.

In some examples, the AI authorization service 136 can dynamically switch between different consent and/or oversight protocols based on active policy profiles. The active policy profiles can be determined by factors such as user role, geographic location, system context, override status, or a combination thereof. For example, the AI authorization service 136 can automatically require additional consent for actions originating in a jurisdiction with stricter regulatory requirements, or can bypass certain non-critical approvals when operating in a low-risk mode, without manual reconfiguration. In this manner, the AI authorization service 136 can adapt consent and oversight requirements based on contextual policy profiles as a configurable governance mechanism.

In some examples, the AI authorization service 136 can include credential bridge logic for integration with external or non-native credentialing platforms. The credential bridge logic can enable cross-system invocation such that users authenticated in an external credentialing system can invoke AI processes governed by the AI authorization service 136 without requiring duplicate credentials and without compromising authorship trace integrity. In some examples, the credential tokens generated or validated by the AI authorization service 136 are constructed to allow cryptographic handshake with external credential platforms, regulatory compliance systems, and/or public-key infrastructures. Token verification can be performed by authorized third parties for audit, compliance, and/or validation purposes without compromising authorship integrity.

If the credential token is absent, expired, revoked, or otherwise fails verification, the AI authorization service 136 can block invocation of all downstream AI models, such as the AI model 132, and record the failed authorization attempt. In some examples, the governance record associated with the failed authorization attempt can be recorded in the on-chain ledger 140 of the blockchain network 116. In some examples, the governance record can be stored in the database 108, exported to a downstream system, transmitted to an external auditor or regulatory body, or stored in any other suitable data store. In some examples, the AI authorization service 136 can record the governance record using a combination of on-chain and off-chain storage, such that a cryptographic hash or pointer is recorded on-chain in the on-chain ledger 140 while detailed audit data is stored off-chain in the database 108 or another data store. In this manner, the storage substrate for the governance record can be technology-neutral, and the AI authorization service 136 can support on-chain ledgering, off-chain database storage, export to external systems, or a combination thereof, without requiring any particular storage implementation. In some examples, the AI authorization service 136 implements revocation propagation such that compromised or expired credential tokens immediately halt analytic execution across all pending actions associated with the compromised credential. In some examples, credential tokens are automatically rotated based on anomaly triggers, policy-defined intervals, or detected behavioral deviations associated with the invoking actor.

In some examples, the AI authorization service 136 can monitor invocation velocity thresholds and invocation pattern anomalies at the system level. For example, the AI authorization service 136 can detect when a rate of invocation requests from a particular credential, endpoint, and/or facility exceeds a configurable velocity threshold, or when invocation patterns exhibit anomalies such as renamed or unrecognized endpoint calls, unusual invocation frequencies, and/or other deviations from expected invocation behavior. Responsive to detection of an invocation velocity threshold being exceeded or an invocation pattern anomaly, the AI authorization service 136 can suppress further invocation, flag the anomalous activity for review, and/or initiate enforcement logic.

If the AI authorization service 136 verifies that the credential token is valid and authorized, the AI authorization service 136 can perform a check on the input data. In some examples, the check is performed using an AI model invoked by the AI authorization service 136. The check can include analyzing semantic consistency of the input data, detecting behavioral deviations associated with the input data, identifying statistical abnormalities of the input data relative to one or more historical baselines (e.g., using historical data 148 included in the at least one database 108), or a combination thereof.

In some examples, the check performed by the AI authorization service 136 can include one or more of a plausibility evaluation, a governance evaluation, a validity evaluation, an authenticity evaluation, a conformance analysis, a policy validation, a provenance validation, a trust adjudication, an anomaly scoring, a risk scoring, a governance scoring, a semantic-policy consistency evaluation, an authorization integrity check, or a combination thereof. In this manner, the check can encompass a range of evaluation types beyond plausibility assessment, enabling the AI authorization service 136 to apply governance logic appropriate to the nature of the request, the applicable policy context, and/or the risk profile associated with the invocation.

Based on the output of the check, the AI authorization service 136 can determine a governance state for the action. The governance state can indicate whether the action may proceed to downstream actions (e.g., a downstream action executed by the AI-based service 124), whether the action requires routing to a credential-verified human reviewer, or whether the action is blocked prior to execution. In some examples, the governance state is determined based on a confidence measure or plausibility metric output by the AI model 144 relative to one or more configurable governance thresholds.

Responsive to the plausibility metric meeting or exceeding a first threshold, the AI authorization service 136 can output a signal authorizing the action to proceed. Responsive to the plausibility metric falling below the first threshold but meeting or exceeding a second threshold, the AI authorization service 136 can route the action to a credential-verified human reviewer (e.g., to at least one user computing device 112). Responsive to the plausibility metric falling below the second threshold, the AI authorization service 136 can block execution of the action.

In some examples, when an action is routed for human review, the AI authorization service 136 transmits to the reviewer a structured explanation including reason codes, model-trace identifiers, and explanation metadata describing why the action was flagged. The human reviewer can be authenticated by the AI authorization service 136 via a credential token with scope-limited permissions. The AI authorization service 136 can receive, from the user computing device 112 associated with the human reviewer, an approval, correction, or denial of the action. The AI authorization service 136 can cryptographically sign the received reviewer's decision and record the decision in a governance record. In some examples, the governance record can be recorded in the on-chain ledger 140 of the blockchain network 116. In some examples, the governance record can be stored in the database 108, exported to a downstream system, or stored in any other suitable data store. The decision can be fed back into a continuous model retraining pipeline to improve the accuracy of the AI model 144 over time. Adaptive routing logic implemented by the AI authorization service 136 can better ensure that human review is invoked only where necessary to avoid workflow fatigue while maintaining governance integrity.

In some examples, the AI authorization service 136 can support a human veto command that allows an authorized credential-verified human reviewer and/or credentialed user to suppress execution or rendering of an AI-generated output even if all other invocation and plausibility thresholds are satisfied. The human veto command can enable a credentialed human to override automated authorization in scenarios involving ethical, emotional, and/or contextual ambiguity, thereby preserving human narrative integrity and oversight authority.

In some examples, the AI authorization service 136 can implement a reviewer succession protocol. The reviewer succession protocol can enable transfer of governance authority from a primary credential-verified human reviewer to a designated credentialed successor in the event that the primary reviewer becomes unable to perform governance duties due to incapacity, transition, or planned succession. The succession protocol can require credential re-issuance, rebinding of invocation fingerprints and/or governance artifacts to the successor, and updating of authorship records under governed trace continuity standards.

In some examples, the AI authorization service 136 implements credential governance routines that are invoked upon detection of behavioral deviations. For example, the AI authorization service 136 can require a secondary credential attestation prior to an action proceeding, can dynamically tighten confidence thresholds for automated approval responsive to detection of a historical deviation, can temporarily suspend an AI-assisted approval pipeline for a specific credential that is pending human review, and/or can adjust AI model invocation permissions based on credential status, credential jurisdiction, or compliance policy. The AI authorization service 136 can execute credential-governance routines prior to execution of a requested action. The AI authorization service 136 can bind the governance routines to the credential used to invoke the analytic process.

In some examples, the AI authorization service 136 can perform monitoring for output-level anomalies including authorship mimicry, content drift, and/or unusual content repetition across sessions. For example, the AI authorization service 136 can flag instances in which AI-generated outputs exhibit patterns indicative of mimicry of a particular authorship style or unusual repetition of content across multiple sessions and/or invocations. Responsive to detection of such anomalies, the AI authorization service 136 can route the flagged outputs for review by a credential-verified human reviewer and/or suppress further rendering or export of the flagged outputs.

The AI authorization service 136 can record a governance record for each governance-related event. Governance-related events can include invocation of the AI model 144, invocation of the AI model 132, determination of a governance state, automated approval or blocking of an action, routing to human review, and credential-verified human reviewer actions. Each governance record generated by the AI authorization service 136 can include at least one of the credential token, an identifier of an AI process (e.g., of the AI model 132), a model version, a validation certificate, a confidence measure, a governance decision, a timestamp, an output of the at least one invoked AI model 132, compliance metadata, and/or a cryptographic reference thereto. In some examples, the AI authorization service 136 stores cryptographic hashes or pointers on-chain in the on-chain ledger 140, while detailed audit data remains off-chain in the database 108 for low-latency adjudication and privacy preservation.

In some examples, the governance record generated by the AI authorization service 136 can include, or can be derived from, one or more of an output digest, an output hash, an output identifier, an execution trace identifier, a model identifier, a process identifier, a model version identifier, a policy version identifier, an authority basis, a review event, a correction event, an approval event, a denial event, a finalization event, a timestamp chain, signature material sufficient for verification of governed provenance, or a combination thereof. In this manner, the governance record can include sufficient binding subject matter to enable downstream verification that a particular output resulted from an authorized governed execution.

In some examples, the governance record can reflect the governing policy state at the time of the governance decision, rather than a generic policy reference. For example, the governance record can include a policy version identifier, a policy hash, and/or a policy snapshot that captures the specific policy rules, thresholds, and/or configuration parameters that were in effect at the time the AI authorization service 136 rendered the governance decision. In this manner, the governance record can provide temporal pinning of the policy state, enabling downstream verification that the governance decision was rendered under a specific and identifiable set of policy conditions.

In some examples, the governance record can reflect a bounded model state at the time of the governance decision. For example, the governance record can include a model version identifier, a model build identifier, a model process identifier, a model hash, and/or other model state information that identifies the specific model instance that produced the output or performed the check at the time of the governance decision. In this manner, the governance record can enable retrospective identification of the exact model state under which a governed act was performed, supporting both enterprise audit requirements and downstream provenance verification.

As used herein, a governance record can refer to any structured, cryptographically verifiable data object generated by the AI authorization service 136 that documents one or more aspects of a governed AI-assisted act. A governance record can include, without limitation, one or more of a credential token or a cryptographic reference thereto, an identifier of a downstream AI process, a model version identifier, a model build identifier, a model process identifier, a policy version identifier, a policy hash, a policy snapshot, an output digest, an output hash, an output identifier, an execution trace identifier, a confidence measure, a governance decision, a timestamp, a timestamp chain, an authority basis, a review event, a correction event, an approval event, a denial event, a finalization event, compliance metadata, signature material, a validation certificate, an authorship fingerprint, a session policy reference, an override or suppression status indicator, an endpoint identifier, a credential tier identifier, source-data references, a use-case class, a final disposition indicator, a receipt identifier, or a combination thereof. The governance record can provide post-hoc attribution of responsibility for the action by identifying the responsible credential holder, enabling traceable accountability across multi-actor environments. In some examples, the governance record is recorded in the on-chain ledger 140 of the blockchain network 116. In some examples, the governance record can be stored in the database 108, exported to a downstream system, transmitted to an external auditor or regulatory body, or stored in any other suitable data store. In some examples, the AI authorization service 136 can record the governance record using a combination of on-chain and off-chain storage. The storage substrate for the governance record can be technology-neutral, such that the AI authorization service 136 can support on-chain ledgering, off-chain database storage, export to external systems, or a combination thereof, without requiring any particular storage implementation.

In some examples, the AI authorization service 136 can automatically construct, for each AI-generated output event, a structured invocation fingerprint object that is distinct from the governance record. The invocation fingerprint object can include an endpoint identifier corresponding to the invocation path or subsystem responsible for the output event, a credential tier identifier associated with the invoking entity, an override or suppression status indicator, a timestamp, a cryptographic hash of the output content, and/or a session policy reference associated with the invocation context. The invocation fingerprint object can be serialized in machine-readable form. The AI authorization service 136 can cryptographically bind the invocation fingerprint object to the AI-generated output by generating a cryptographic hash of the serialized invocation fingerprint object and applying a digital signature to the hashed invocation fingerprint object using a system-managed private key, yielding a digitally signed invocation fingerprint object that constitutes a verifiable machine artifact.

In some examples, the AI authorization service 136 can cryptographically bind the governance record to the output of the governed AI execution, such that the governance record and the output are linked by a cryptographic relationship that can be independently verified. For example, the AI authorization service 136 can include within the governance record a digest, hash, or other cryptographic representation of at least a portion of the output, and can digitally sign the governance record inclusive of the output-derived cryptographic representation. In this manner, the governance record can constitute a portable, cryptographically verifiable governance artifact that is bound to the governed execution and capable of substantiating the provenance of the resulting output. A downstream verifier can establish, based on the governance artifact, that the downstream AI process was authorized and that the output, or an output-derived identifier such as a digest, hash, execution identifier, or other bound reference, corresponds to the governed execution. In some examples, the cryptographic binding between the governance artifact and the output can be verified outside the originating execution context, enabling portable proof of governed provenance that can be checked beyond the issuing platform without requiring access to the originating infrastructure.

In some examples, the endpoint identifier included in the invocation fingerprint object can correspond to a specific invocation path, subsystem, API route, and/or module responsible for the output event within the AI authorization service 136 or an associated AI-based service. For example, the endpoint identifier can identify which subsystem or invocation path within a multi-module architecture was responsible for generating a particular output event, enabling downstream systems, auditors, and/or regulators to trace the output event to a specific invocation path or subsystem without requiring access to internal system topology. In this manner, the endpoint identifier can provide architectural specificity that enables differentiation between output events generated by different subsystems, invocation paths, and/or modules within the same computing system.

In some examples, the AI authorization service 136 can condition export, transmission, and/or rendering of an AI-generated output on runtime validation of the digitally signed invocation fingerprint object associated with the output. For example, the AI authorization service 136 can associate the digitally signed invocation fingerprint object with the AI-generated output via embedded metadata or a cryptographically linked companion payload, and can prevent export, transmission, or rendering of the AI-generated output unless validation of the digitally signed invocation fingerprint object is satisfied. Validation can include digital signature verification, credential-tier state validation, token expiration validation, revocation state validation, or a combination thereof. Export conditioning can occur at runtime prior to output propagation, such that the invocation fingerprint object serves as a mandatory cryptographically verifiable precondition for output propagation.

In some examples, the AI authorization service 136 can treat runtime export conditioning as a distinct enforcement mechanism that operates independently of other governance functions such as checking and/or credential verification. Runtime export conditioning can prevent export, transmission, and/or rendering of a symbolic output unless validation of the digitally signed invocation fingerprint object associated with the symbolic output is satisfied at runtime prior to output propagation. In that regard, the digitally signed invocation fingerprint object can serve as a mandatory cryptographically verifiable precondition for output propagation, such that no AI-generated output can be exported, transmitted, and/or rendered without a valid and verified invocation fingerprint object accompanying the output.

In some examples, validation performed during runtime export conditioning can include one or more of digital signature verification of the invocation fingerprint object, credential-tier state validation to confirm that the credential tier associated with the invoking entity remains valid and authorized, token expiration validation to confirm that the invocation artifact has not exceeded a configured time-to-live interval, revocation state validation to confirm that the credential and/or invocation artifact has not been revoked, or a combination thereof. The AI authorization service 136 can associate the digitally signed invocation fingerprint object with the AI-generated output via embedded metadata and/or a cryptographically linked companion payload, and can suppress export, transmission, and/or rendering of the AI-generated output responsive to any validation step failing. In this manner, runtime export conditioning can operate as a gate that conditions output propagation on the integrity and validity of the invocation fingerprint object at the time of export, rather than at the time of initial invocation alone.

In some examples, the governance records and/or receipts generated by the AI authorization service 136 can be designed to meet requirements for self-authenticating electronic records under Federal Rule of Evidence 902, such that the governance records and/or receipts can authenticate themselves without extrinsic evidence of authenticity. In some examples, the governance records and/or receipts generated by the AI authorization service 136 can additionally or alternatively be designed to meet requirements under Federal Rule of Evidence 1002. In this manner, the AI authorization service 136 can generate cryptographically verifiable records of authorized AI execution that may be introduced as machine-generated evidence in regulatory, compliance, and/or legal contexts.

In some examples, the receipts generated by the AI authorization service 136 are not limited to internal logging. The AI authorization service 136 can produce a cryptographically signed record of authorized AI execution that can be exported from the originating system and independently verified by downstream systems, auditors, regulators, and/or courts without requiring access to the originating infrastructure. In this manner, the evidence of AI authorization and execution can travel with the AI-generated output as a portable evidence artifact, enabling independent verification at any point in a downstream workflow.

In some examples, the governance records and/or receipts generated by the AI authorization service 136 can support verification of governed provenance outside the originating execution context. For example, a downstream system, auditor, regulator, or other third party can verify, based on the exported governance artifact, that a particular output resulted from an authorized governed execution, that the credential holder was authorized to invoke the downstream AI process, and that the output or an output-derived identifier such as a digest, hash, execution identifier, or other bound reference corresponds to the governed execution. In this manner, the governance artifact can function as portable proof of governed provenance that can be checked beyond the issuing platform, rather than functioning solely as a signed request log or internal audit record. The AI authorization service 136 can generate the governance artifact such that verification does not require a specific verifier model, enabling interoperability across diverse verification environments.

In some examples, the AI authorization service 136 can trigger licensing and/or usage-based events upon invocation, validation, export, and/or reuse of AI-generated outputs. For example, invocation of governed AI-generated outputs can be metered, licensed, and/or billed according to usage-based triggers, credential-tier activation, and/or oversight tiers. Licensing models can include per-invocation tokens, session caps, escrowed governance audits, or a combination thereof. Structures can be determined by deployment mode, risk profile, and/or sector-specific adoption parameters.

In some examples, the AI authorization service 136 can maintain suppression-specific audit logs for invocation suppression events. Each suppression audit log entry can include an invocation suppression trigger credential, an invocation endpoint identity, an identifier of affected data or output, a suppression timestamp, and/or a trace reattachment condition if applicable. The suppression audit logs can be cryptographically verifiable and trace-readable. In some examples, an unauthorized suppression event can invalidate governance compliance.

In some examples, the AI authorization service 136 can include a trace continuity module configured to preserve invocation context, reviewer lineage, and/or authorship continuity across sessions, deployments, and/or AI model migrations. The trace continuity module can bind invocation context data, reviewer lineage information, and/or an authorship hash to successive AI-generated outputs to maintain governance state continuity when the underlying AI model is updated, migrated, or replaced. In this manner, governance records and invocation artifacts can maintain traceability across system updates and model transitions.

In some examples, the AI authorization service 136 can manage a lifecycle of the governance artifact that extends beyond initial generation. For example, the governance artifact can be generated before execution of the downstream AI process, updated during human review or correction, bound upon execution of the downstream AI process, and preserved, exported, revoked, superseded, supplemented, or otherwise carried forward across downstream lifecycle events. In some examples, the AI authorization service 136 can generate a preliminary governance artifact at the time of credential verification and pre-invocation governance evaluation, and can update the governance artifact responsive to subsequent lifecycle events such as execution of the downstream AI process, human review, correction, approval, denial, finalization, export, or reuse. In this manner, the governance artifact can function as a living governance object that reflects the full lifecycle of the governed act, rather than functioning solely as a one-time gate or point-in-time record.

In some examples, the AI authorization service 136 can support lifecycle continuity through supersession and/or amendment of governance artifacts. For example, when a later governed act supersedes, amends, corrects, or supplements an earlier governed act, the AI authorization service 136 can generate a new governance artifact that references the earlier governance artifact and records the supersession, amendment, correction, or supplementation event. The AI authorization service 136 can preserve chain integrity across successive governance artifacts, such that the earlier governance artifact remains intact and verifiable while the later governance artifact records the nature and basis of the change. In this manner, the AI authorization service 136 can maintain a linked chain of governance artifacts that supports retrospective review of the full governance history of a governed act, distinguishing the governance architecture from ordinary logging systems that overwrite or silently replace earlier records.

In some examples, the AI authorization service 136 supports federated, privacy-preserving collaboration across a plurality of participating organizations. In that regard, participating organizations can exchange encrypted model invocation parameters rather than raw patient data to enable shared fraud-pattern learning across jurisdictions while honoring applicable privacy constraints. Secure aggregation and zero-knowledge proofs can allow the AI model 144 to learn from cross-organizational patterns, such as anomalous coding behaviors spreading across multiple facilities or geographic regions, without exposing protected information. In some examples, the AI authorization service 136 detects and scrubs personally identifying information (PII) from input data prior to recording the governance record.

In some examples, the AI authorization service 136 can support a public trace exposure mode in which the AI authorization service 136 publishes de-identified summaries of governance records and/or invocation trace logs under a transparency framework. Prior to publication, identifying details and sensitive content can be stripped or anonymized, and a credential-verified human reviewer can review and approve the content for release. The public trace exposure mode can enable organizations, such as public institutions and/or research collaborations, to demonstrate the integrity and compliance of AI systems to external stakeholders without revealing proprietary or personally identifying data.

In some examples, the AI authorization service 136 can enforce a restriction on downstream use of governance records, invocation artifacts, and/or AI-generated outputs as training data for other AI models and/or for fine-tuning large language models. The restriction can prohibit use of governed outputs and associated trace data as training data unless explicitly licensed. In this manner, the AI authorization service 136 can reduce the risk that governed outputs and sensitive trace data inadvertently enter the training corpora of other systems.

In some examples, the on-chain ledger 140 supports logical deletion through cryptographic key destruction, enabling lawful right-to-be-forgotten operations without compromising chain integrity. In that regard, bidirectional data synchronization implemented by the AI authorization service 136 can provide rollback and disaster-recovery continuity. The AI authorization service 136 can further implement adversarial-resilience measures, including randomized validation probes, differential-privacy padding, and watermarking, to defend against evasion or spoofing of the credential-governance and plausibility-check mechanisms.

In some examples, the AI-based service 124 and the AI authorization service 136 are provided on the same system computing device 104. In other examples, the AI-based service 124 and the AI authorization service 136 are provided on separate system computing devices 104 communicatively connected over the communications network 120. In still other examples, the AI-based service 124 and/or the AI authorization service 136 are distributed across a plurality of system computing devices 104, such that one or more components of the AI-based service 124 and/or the AI authorization service 136 execute on different computing devices within the computing system 100.

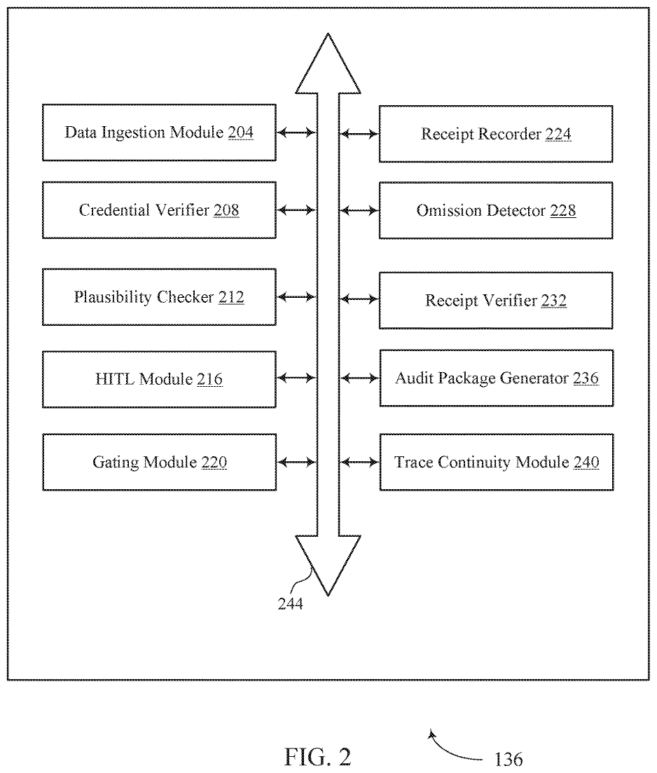

FIG. 2 is a block diagram of example components of the AI authorization service 136, according to the present teachings. In some cases, the components of the AI authorization service 136 can be implemented as part of one or more processors. In some instances, the components of the AI authorization service 136 may be implemented by a single device (e.g., system computing device 104) that includes separate components or modules as shown in the example of FIG. 1. However, in other instances, the components of the AI authorization service 136 may be part of a collection of individual devices, wherein each device may include one or more modules.

The AI authorization service 136 may include, without limitation, a data ingestion module 204, a credential verifier 208, a checker 212, a human-in-the-loop (HITL) module 216, a gating module 220, a receipt recorder 224, an omission detector 228, a receipt verifier 232, an audit package generator 236, and/or a trace continuity module 240.

The data ingestion module 204 can receive and normalize heterogeneous input data from a plurality of external data sources. For example, the data ingestion module 204 can accept structured and unstructured data through one or more standards-agnostic interfaces. The data ingestion module 204 can normalize inbound data through credential-verified gateways using tokenized identities and role-based access controls. In some examples, the data ingestion module 204 performs data-quality scoring and semantic-version tracking to maintain vocabulary currency as coding standards evolve.

The credential verifier 208 can receive a credential token associated with an invoking entity and determine whether the credential token authorizes invocation of at least one downstream AI process. For example, the credential verifier 208 can verify a cryptographic signature of the credential token to confirm authenticity and tamper resistance, validate that the credential token has not expired based on a validity period encoded therein, confirm that the credential token has not been revoked by querying a credential registry or revocation list, and determine that role, facility, and/or jurisdictional attributes encoded in the credential token authorize invocation of a requested AI model for a particular action type. In some examples, the credential verifier 208 implements revocation propagation such that compromised or expired credential tokens immediately halt analytic execution across all pending actions associated with the compromised credential. In some examples, the credential verifier 208 supports automatic rotation of credential tokens based on anomaly triggers, policy-defined intervals, or detected behavioral deviations associated with the invoking actor.

In some examples, the credential verifier 208 can enforce configurable TTL intervals for credential tokens and/or invocation artifacts. The TTL intervals can define an expiration lifespan governed by a policy-configurable setting, enabling alignment with data retention policies. In some examples, the credential verifier 208 can enforce credential inactivity-based expiration such that invocation credentials expire upon lapse of use, credential inactivity, trace validation failure, or after a defined maximum interval from issuance without reaffirmed activity by the credential holder. Credential expiration events can trigger automated suppression of invocation rights associated with the expired credential until re-credentialing occurs.

In some examples, the credential verifier 208 can dynamically switch between different consent and/or oversight protocols based on active policy profiles determined by factors such as user role, geographic location, system context, override status, or a combination thereof. For example, the credential verifier 208 can require additional consent for actions originating in a jurisdiction with stricter regulatory requirements, or can bypass certain non-critical approvals when operating in a low-risk mode, without manual reconfiguration.

In some examples, the credential verifier 208 can include credential bridge logic for integration with external credentialing platforms. The credential bridge logic can enable cross-system invocation such that users authenticated in an external credentialing system can invoke AI processes governed by the AI authorization service 136 without requiring duplicate credentials. In some examples, the credential verifier 208 can perform cryptographic handshake with external credential platforms, regulatory compliance systems, and/or public-key infrastructures to validate credential tokens issued by external systems.

The checker 212 can perform a check on input data associated with a request to determine whether the request is plausible, potentially anomalous, or potentially fraudulent. For example, the checker 212 can analyze semantic consistency between structured data items and unstructured data items included in the input, detect behavioral deviations in request patterns associated with a particular credential, user role, department, site, and/or facility, and identify statistical abnormalities of the input data relative to one or more historical baselines stored in the at least one database 108. The checker 212 can output a confidence measure or plausibility metric indicative of a degree of plausibility of the request. In some examples, the checker 212 includes, invokes, or is otherwise implemented using at least one AI model. In some examples, authorization to invoke an AI model associated with the checker may be governed by the credential verifier 208.

In some examples, the checker 212 and/or the credential verifier 208 can monitor invocation velocity thresholds and invocation pattern anomalies. For example, the checker 212 can detect when a rate of invocation requests from a particular credential, endpoint, and/or facility exceeds a configurable velocity threshold, or when invocation patterns exhibit anomalies such as renamed or unrecognized endpoint calls and/or unusual invocation frequencies. Responsive to detection of an invocation velocity threshold being exceeded or an invocation pattern anomaly, the checker 212 can flag the anomalous activity for review and/or initiate enforcement logic.

In some examples, the checker 212 can perform monitoring for output-level anomalies including authorship mimicry, content drift, and/or unusual content repetition across sessions. The checker 212 can flag instances in which AI-generated outputs exhibit patterns indicative of mimicry of a particular authorship style or unusual repetition of content across multiple sessions and/or invocations, and can route flagged outputs for review by a credential-verified human reviewer via the HITL module 216.

The HITL module 216 can route a request to a credential-verified human reviewer responsive to a determination that the request requires human oversight. For example, the HITL module 216 can transmit to the reviewer a structured explanation including reason codes, model-trace identifiers, and explanation metadata describing why the action was flagged. The HITL module 216 can authenticate the human reviewer via a credential token with scope-limited permissions. The HITL module 216 can receive, from a computing device associated with the human reviewer, an approval, correction, or denial of the request. In some examples, the HITL module 216 implements adaptive routing logic to invoke human review only where necessary to avoid workflow fatigue while maintaining governance integrity.

In some examples, the HITL module 216 can support a human veto command that allows an authorized credential-verified human reviewer and/or credentialed user to suppress execution or rendering of an AI-generated output even if all other invocation and plausibility thresholds are satisfied. The human veto command can enable a credentialed human to override automated authorization in scenarios involving ethical, emotional, and/or contextual ambiguity.

In some examples, the AI authorization service 136 can structurally preserve a distinction between a machine-originated output generated by an AI model and a human-reviewed, corrected, and/or finalized outcome produced after human intervention via the HITL module 216. For example, the receipt recorder 224 can record, within a governance receipt, both the original AI-generated output as produced by the AI model at the time of invocation and the final human-approved version as modified, corrected, and/or finalized by a credential-verified human reviewer. The governance receipt can preserve the original AI-generated output in an unaltered state and can separately record the final human-approved version, enabling downstream comparison between the machine-originated output and the human-finalized outcome. In this manner, the governance receipt can maintain an authorship and provenance chain that is structurally preserved and independently verifiable, enabling downstream systems, auditors, and/or regulators to evaluate the nature and extent of human intervention in the governed act.

In some examples, the audit package generator 236 can include, within a portable audit package, the original AI-generated output, the final human-approved version, and metadata identifying the credential-verified human reviewer, a timestamp of the human review action, and/or an indication of the type of human intervention (e.g., approval without modification, correction, and/or denial). In this manner, the portable audit package can enable independent third-party verification of the respective contributions of the AI model and the human reviewer to the final output, without requiring access to internal system logs and/or proprietary interfaces of the AI authorization service 136.

In some examples, the HITL module 216 can implement a reviewer succession protocol that enables transfer of governance authority from a primary credential-verified human reviewer to a designated credentialed successor in the event that the primary reviewer becomes unable to perform governance duties due to incapacity, transition, or planned succession. The reviewer succession protocol can require credential re-issuance, rebinding of invocation fingerprints and/or governance artifacts to the successor, and updating of authorship records under governed trace continuity standards.

The gating module 220 can determine a governance state for a request based on an output of the checker 212. The governance state can indicate whether the action may proceed to downstream actions, whether the action requires routing to a credential-verified human reviewer via the HITL module 216, or whether the action is blocked prior to execution. In some examples, the gating module 220 determines the governance state based on a confidence measure or plausibility metric output by the checker 212 relative to one or more configurable governance thresholds. Responsive to the plausibility metric meeting or exceeding a first threshold, the gating module 220 can output a signal authorizing the action to proceed. Responsive to the plausibility metric falling below the first threshold but meeting or exceeding a second threshold, the gating module 220 can route the action to the HITL module 216 for human review. Responsive to the plausibility metric falling below the second threshold, the gating module 220 can block execution of the action.

In some examples, the gating module 220 can condition export, transmission, and/or rendering of an AI-generated output on runtime validation of a digitally signed invocation fingerprint object associated with the output. The gating module 220 can prevent export, transmission, or rendering of the AI-generated output unless validation of the digitally signed invocation fingerprint object is satisfied, including digital signature verification, credential-tier state validation, token expiration validation, and/or revocation state validation. In this manner, the invocation fingerprint object can serve as a mandatory cryptographically verifiable precondition for output propagation.

The receipt recorder 224 can generate a cryptographically signed receipt for each governance-related event processed by the AI authorization service 136. The receipt can include at least one of the credential token, an identifier of an AI process, a model version, a validation certificate, a confidence measure, a governance decision, a timestamp, compliance metadata, and/or a cryptographic reference thereto. In some examples, the receipt recorder 224 records the receipt in the on-chain ledger 140 of the blockchain network 116. In some examples, the receipt recorder 224 stores cryptographic hashes or pointers on-chain in the on-chain ledger 140, while detailed audit data remains off-chain in the database 108 for low-latency adjudication and privacy preservation. The receipt can be designed to meet requirements for self-authenticating electronic records under Federal Rule of Evidence 902, such that the receipt can authenticate itself without extrinsic evidence of authenticity. In some examples, the receipt can additionally or alternatively be designed to meet requirements under Federal Rule of Evidence 1002. In this manner, the receipt recorder 224 can generate cryptographically verifiable records of authorized AI execution that may be independently verified by downstream systems, auditors, regulators, and/or other third parties without access to the originating infrastructure.

In some examples, the receipt recorder 224 can automatically construct, for each governance-related event, a structured invocation fingerprint object comprising an endpoint identifier corresponding to the invocation path or subsystem responsible for the output event, a credential tier identifier associated with the invoking entity, an override or suppression status indicator, a timestamp, a cryptographic hash of the output content, and/or a session policy reference associated with the invocation context. The invocation fingerprint object can be serialized in machine-readable form, hashed, and digitally signed using a system-managed private key to yield a verifiable machine artifact that is distinct from the governance record recorded in the on-chain ledger 140.

In some examples, the receipt recorder 224 can construct the receipt and/or the invocation fingerprint object to include one or more additional metadata fields. The additional metadata fields can include a use-case class field identifying a category or type of AI-assisted act associated with the governance event, a source-data references field identifying specific source data accessed and/or bound at the time of AI output generation, a final disposition field indicating a final export action and/or disposition event associated with the AI-generated output, a receipt identifier field comprising a unique identifier for the receipt as a standalone artifact, or a combination thereof. In some examples, the receipt recorder 224 can further include in the receipt an invoker identity field, a role or authority class field, a timestamp field, a context identifier field, a model name and/or version field, an output hash field, a human review action field, and/or a signature marker field. In this manner, the receipt can function as a self-contained record of the governed AI-assisted act that includes sufficient metadata to enable independent reconstruction and verification of the invocation context, source data provenance, and final disposition of the AI-generated output.

In some examples, the receipt recorder 224 can construct the receipt and/or the invocation fingerprint object with a cryptographically bound hash that encapsulates an endpoint identifier, a credential tier identifier, override or fallback trace data, an authorship fingerprint, and/or a session policy reference. The cryptographically bound hash can enable detection of tampering with the receipt and/or invocation fingerprint object and can enable verification of the contents thereof as a single integrity-checked payload.

In some examples, the receipt recorder 224 can trigger licensing and/or usage-based particular events upon invocation, validation, export, and/or reuse of AI-generated outputs. Invocation of governed AI-generated outputs can be metered, licensed, and/or billed according to usage-based triggers, credential-tier activation, and/or oversight tiers.

In some examples, the receipt recorder 224 and/or the omission detector 228 can maintain suppression-specific audit logs for invocation suppression events. Each suppression audit log entry can include an invocation suppression trigger credential, an invocation endpoint identity, an identifier of affected data or output, a suppression timestamp, and/or a trace reattachment condition if applicable. The suppression audit logs can be cryptographically verifiable and trace-readable.

The receipt verifier 232 can independently validate the authenticity of a receipt artifact generated by the receipt recorder 224 without requiring access to the originating system. For example, the receipt verifier 232 can verify a digital signature of the receipt using a public key associated with the AI authorization service 136, confirm that the receipt has not been tampered with by comparing a cryptographic hash of the receipt contents against the signed hash, and validate that the credential token, timestamp, and governance decision encoded in the receipt are consistent and unaltered. In some examples, the receipt verifier 232 is made available to authorized third parties, such as regulators, auditors, or downstream systems, to enable independent confirmation that a receipt is valid and untampered.

In some examples, the receipt verifier 232 can be designed for accessibility by third parties, such as regulators, auditors, courts, payers, and/or downstream systems, to enable independent confirmation that a receipt is valid and untampered without requiring access to the originating system. In some examples, the receipt verifier 232 can be made available as an open or publicly accessible verification tool, with the proprietary aspects of the AI authorization service 136 residing in the authorization layer and receipt generation rather than in the verification mechanism. In this manner, the AI authorization service 136 can enable broad trust and interoperability around the receipt format while maintaining proprietary control over the credential-governed invocation and receipt generation infrastructure.

The audit package generator 236 can automatically construct a portable audit package for a governance-related event. The audit package can include the receipt generated by the receipt recorder 224, relevant metadata associated with the governance event, a cryptographic hash of the associated output, and verification information sufficient to permit independent third-party validation via public key verification. The audit package can be exported to downstream systems, auditors, regulators, or other authorized parties. In some examples, the audit package generator 236 constructs the audit package without manual intervention, such that the audit package functions as a portable evidence bundle documenting authorized AI execution and associated outputs. Independent third-party verification of the audit package may be performed without access to internal system logs or proprietary interfaces of the AI authorization service 136.

In some examples, the audit package generated by the audit package generator 236 can be designed to travel with the AI-generated output as a portable evidence artifact. The audit package can be exported from the originating system and independently verified by downstream systems, auditors, regulators, and/or courts without requiring access to the originating infrastructure. In this manner, the evidence of AI authorization and execution is not limited to internal logging but can accompany the output through downstream workflows.

In some examples, the audit package generated by the audit package generator 236 can constitute a portable governance artifact that is capable of substantiating governed provenance outside the originating platform. The portable governance artifact can include, or can be checked against, a digest, identifier, signature input, or provenance binding for at least a portion of the output of the governed AI execution. In this manner, the portable governance artifact can enable a downstream recipient to verify that the output was produced pursuant to an authorized governed execution, rather than functioning solely as an audit object that is only loosely related to the output.

In some examples, the audit package generator 236 can support a public trace exposure mode in which the audit package generator 236 produces de-identified summaries of governance records and/or invocation trace logs for publication under a transparency framework. Prior to publication, identifying details and sensitive content can be stripped or anonymized. A credential-verified human reviewer can review and approve the de-identified summaries for release, enabling organizations to demonstrate the integrity and compliance of AI systems to external stakeholders without revealing proprietary or personally identifying data.

In some examples, the AI authorization service 136 can enforce a restriction on downstream use of governance records, invocation artifacts, receipts, audit packages, and/or AI-generated outputs as training data for other AI models and/or for fine-tuning large language models. The restriction can prohibit use of governed outputs and associated trace data as training data unless explicitly licensed, reducing the risk that governed outputs and sensitive trace data inadvertently enter the training corpora of other systems.

In some examples, the trace continuity module 240 of the AI authorization service 136 can be configured to preserve invocation context, reviewer lineage, and/or authorship continuity across sessions, deployments, and/or AI model migrations. The trace continuity module 240 can bind invocation context data, reviewer lineage information, and/or an authorship hash to successive AI-generated outputs to maintain governance state continuity when the underlying AI model is updated, migrated, or replaced. In this manner, governance records and invocation artifacts can maintain traceability across system updates and model transitions.

In some examples, the components of AI authorization service 136 may be interconnected and communicate via a bus 244. The bus 244 may enable communication via any standard or specification such as peripheral component interconnect, peripheral component interconnect express, parallel advanced technology attachment, or serial advanced technology attachment. The at least one bus 244 may be provided in the form of a single bus or multiple buses that are operatively interconnected.

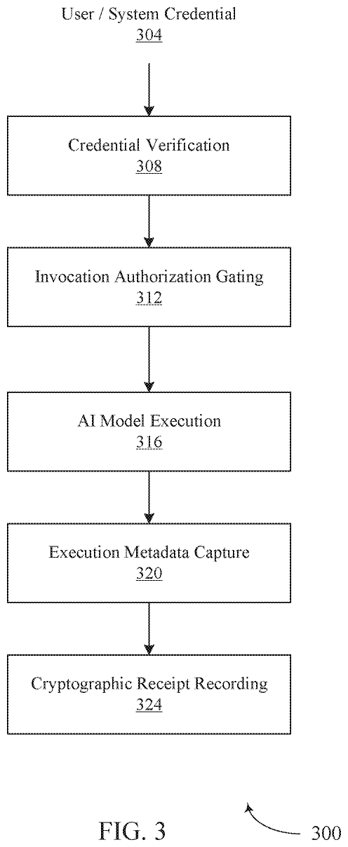

FIG. 3 illustrates an example process 300 for AI governance using the AI authorization service 136, according to the present teachings. Although the process steps are described with reference to the systems and processes of FIGS. 1-2, persons skilled in the art will understand that any system adapted to implement the process steps, in any order, falls within the scope of the present invention.

In some examples, the process 300 can be initiated responsive to receipt of a user or system credential 304. The user or system credential 304 can be received, for example, from a user computing device 112 requesting authorization to execute an AI model, such as the AI model 132 of the AI-based service 124.

At step 308, the process 300 can include performing credential verification with respect to the received credential 304. In some examples, credential verification at step 308 can be performed using the credential verifier 208 described with respect to FIG. 2. For example, credential verification at step 308 can include verifying a cryptographic signature of the credential token to confirm authenticity and tamper resistance, validating that the credential token has not expired, confirming that the credential token has not been revoked, and determining that attributes encoded in the credential token authorize invocation of a requested AI process for a particular action type.

At step 312, the process 300 can include performing invocation authorization gating. In some examples, invocation authorization gating at step 312 can be performed using the checker 212, the HITL module 216, and/or the gating module 220 described with respect to FIG. 2. For example, the invocation authorization gating at step 312 can include performing a check on input data associated with the request, determining a governance state for the action based on a confidence measure or plausibility metric output by the check, and selectively authorizing the action to proceed, routing the action for human review, or blocking execution of the action based on the governance state.

At step 316, the process 300 can include AI model authorization and execution. In some examples, AI model authorization and execution at step 316 can be performed using the gating module 220 described with respect to FIG. 2 in conjunction with the AI model 132 of the AI-based service 124 described with respect to FIG. 1. For example, AI model authorization and execution can include outputting, by the gating module 220, a signal authorizing invocation of the AI model 132 responsive to a successful credential verification and a check that meets or exceeds a governance threshold, and executing the AI model 132 to process the request.

At step 320, the process 300 can include capturing execution metadata associated with the authorized and/or executed AI operation. In some examples, metadata capture at step 320 can be performed by the receipt recorder 224 described with respect to FIG. 2. For example, metadata capture can include recording the credential token associated with the invoking actor, an identifier and version of the AI model that performed the operation, a confidence measure or plausibility metric output by the check, a governance decision indicating whether the action was authorized, blocked, or routed for human review, a timestamp corresponding to the execution event, a jurisdictional or policy context associated with the action, and/or compliance metadata.

At step 324, the process 300 can include cryptographic receipt recording. In some examples, cryptographic receipt recording at step 324 can be performed by the receipt recorder 224 described with respect to FIG. 2 in conjunction with the blockchain network 116 and/or the database 108 described with respect to FIG. 1. For example, cryptographic receipt recording can include generating a cryptographically signed receipt that encapsulates the execution metadata captured at step 320, recording the receipt or a cryptographic hash thereof in the on-chain ledger 140 of the blockchain network 116, and storing detailed audit data off-chain in the database 108. The cryptographically signed receipt can be independently verifiable by downstream systems, auditors, or regulators without access to the originating infrastructure.

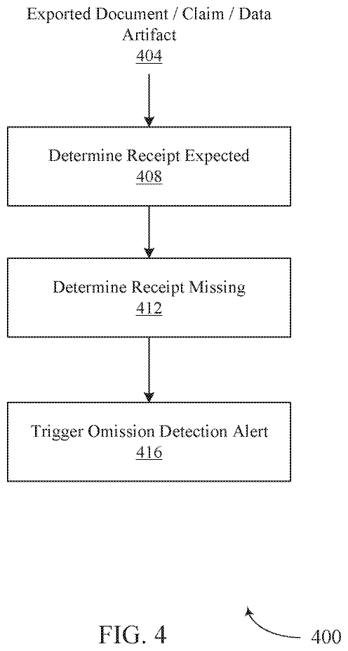

FIG. 4 illustrates an example process 400 for performing receipt omission detection with respect to AI-generated outputs, according to the present teachings. Although the process steps are described with reference to the systems and processes of FIGS. 1-3, persons skilled in the art will understand that any system adapted to implement the process steps, in any order, falls within the scope of the present invention. In some examples, operations included in the process 400 are performed by the omission detector 228 of the AI authorization service 136.

In some examples, the process 400 can be initiated responsive to receipt of an exported document, claim, or other data artifact 404. For example, the document, claim, or other data artifact 404 can include an AI-generated output such as a processed action result, a claim, a document, a report, a decision summary, or other data artifact that is associated with execution of an AI model such as the AI model 132. The data artifact 404 can be received from a downstream system, an external auditor, a regulatory body, or another component of the computing system 100.

At 408, the process 400 can include determining that a receipt indicative of an AI operation should be included with the input 404. For example, the omission detector 228 can analyze the data artifact 404 to determine whether the data artifact 404 is of a type or category that is expected to have an associated cryptographically signed receipt based on one or more governance policies. The omission detector 228 can compare the data artifact 404 against an invocation registry to determine whether a corresponding receipt was generated during execution of the AI process that produced the data artifact 404. In some examples, the omission detector 228 can detect indicators within the data artifact 404, such as model-trace identifiers, output formatting patterns, or metadata signatures, that indicate the data artifact 404 was generated or influenced by an AI process for which a receipt is expected.

At step 412, the process 400 can include detecting that a receipt is missing. For example, the omission detector 228 can determine that the data artifact 404 does not include an associated valid receipt, that a receipt expected to accompany the data artifact 404 is absent from the invocation registry, or that receipt metadata expected to be embedded in or linked to the data artifact 404 is not present. In some examples, the omission detector 228 can detect a missing receipt by performing a validation check during export package construction and determining that the validation check fails due to absence of a required receipt.

At step 416, the process 400 can include triggering an alert indicative of receipt omission. For example, the omission detector 228 can output at least one signal to an administrative computing device, a user computing device, or another component of the AI authorization service 136 indicating that a receipt expected to accompany the data artifact 404 is missing. In some examples, the omission detector 228 can suppress export or further propagation of the data artifact 404 responsive to detecting the receipt omission. In some examples, the omission detector 228 can initiate enforcement logic, such as flagging the data artifact 404 for compliance review, recording the omission event (e.g., in the on-chain ledger 140 or elsewhere), or routing the data artifact 404 for credential-verified human review prior to permitting further processing.

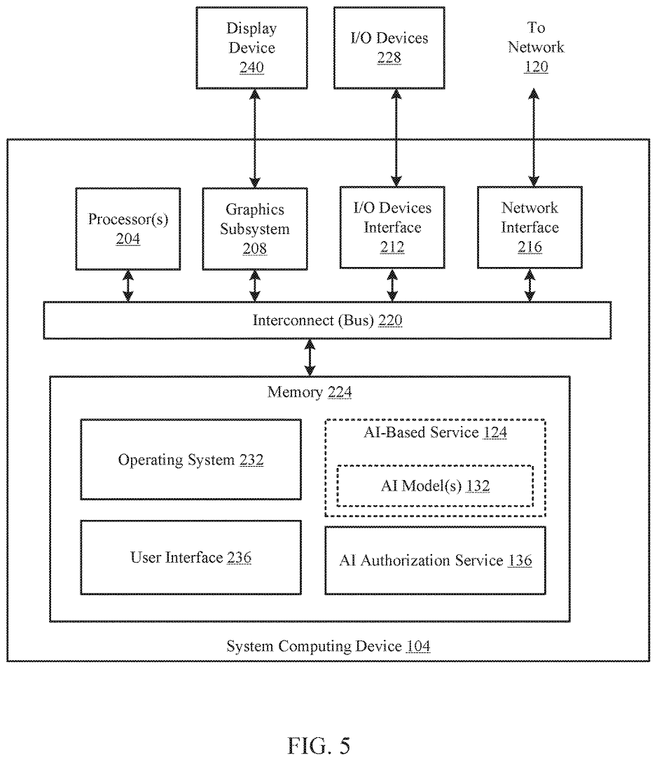

FIG. 5 is a block diagram of the system computing device 104 that may be implemented in conjunction with the computing system 100 of FIG. 1, according to present teachings. As shown in FIG. 5, the system computing device 104 can include, without limitation, a processor 504 (e.g., at least one processor 504), a graphics subsystem 508, an input/output (I/O) device interface 512, a network interface 516, an interconnect 520, and a memory 524. The interconnect, or bus, 520 can include one or more wires, cables, traces, contacts, analog components, digital components, wireless connection components, and/or other suitable means for interconnecting hardware components of the system computing device 104.

The processor 504 is adapted to retrieve and execute programming instructions, such as the AI-based service 124 and/or AI authorization service 136, stored in the memory 524. Similarly, the processor 504 is adapted to store application data (e.g., software libraries) and retrieve application data from the memory 524 related to execution of the AI-based service 124 and/or AI authorization service 136. The interconnect 520 is adapted to facilitate transmission of data, such as programming instructions and application data, between the processor 504, the graphics subsystem 508, the I/O device interface 512, the network interface 516, and the memory 524. The I/O device interface 512 is adapted to receive input data from I/O devices 528 and transmit the input data to the processor 504 via the interconnect 520. For example, I/O devices 528 may include one or more buttons, a keyboard, a mouse, and/or other input devices. The I/O device interface 512 is further adapted to receive output data from the processor 504 via the interconnect 520 and transmit the output data to the I/O devices 528.

The memory 524 may store programming instructions and application data that comprise an operating system 532, a user interface 536, the AI-based service 124, and/or the AI authorization service 136. The operating system 532 can perform system management functions such as managing hardware devices including the graphics subsystem 508 and I/O device interface 512. The user interface 536, such as a window and object metaphor, may provide a mechanism for user interaction with a display device 540 communicatively connected to the graphics subsystem 508.

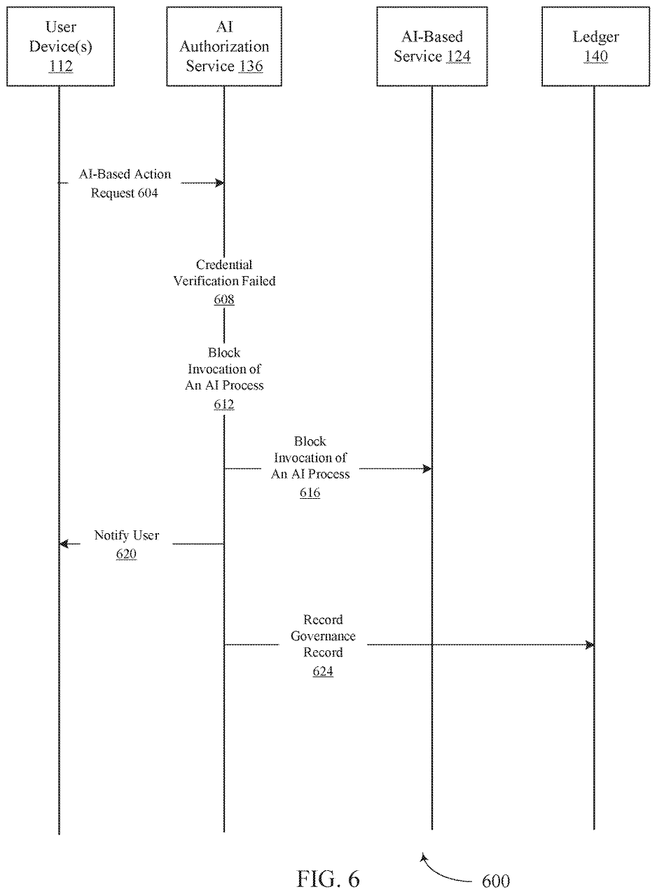

FIG. 6 is a swimlane diagram for an authentication workflow 600 in which an authenticated credential for AI invocation is not detected, according to the present teachings. At 604, the AI authorization service 136 can receive a payload associated with a requested action. In some examples, the payload is received from the user computing device 112. In other examples, the payload is forwarded to the AI authorization service 136 by the AI-based service 124 responsive to a request output by the user computing device 112.

At 608, the authorization service 136 determines that the payload does not include a credential associated with an upstream component that invokes the authentication process of the AI authorization service or that a credential token included in the payload is not valid. For example, the AI authorization service 136 can determine that the payload does not include a credential token, or that a credential token included in the payload has an invalid or unverifiable cryptographic signature, has expired based on a validity period encoded in the token, has been revoked by a credential registry or identity provider, does not encode a role, facility, or jurisdictional attribute that authorizes invocation of the requested AI model for the particular action type, or otherwise fails verification against one or more credential validation policies. In some examples, the AI authorization service 136 queries a credential registry or revocation list to determine whether the credential token remains valid and has not been compromised. In some examples, the AI authorization service 136 determines that the credential token is absent from the payload entirely, indicating that the invoking component did not supply a credential for AI invocation.

At 612, responsive to the failed authentication and/or absence of the credential, the AI authorization service 136 blocks invocation of one or more downstream AI processes. For example, the AI authorization service 136 can output a signal to the AI-based service 124 to block invocation of the AI model 132 of the AI-based service 124.

At 620, the AI authorization service 136 can output at least one signal to the user computing device 112 and/or to an administrative computing device, notifying a user and/or administrator of the failed authentication. For example, the AI authorization service 136 can transmit a notification to the user computing device 112 indicating the reason for the authentication failure, such as an absent, expired, revoked, or unauthorized credential token. In some examples, the AI authorization service 136 can require secondary credential attestation, such as role-bound or facility-bound re-validation, before permitting the invoking actor to resubmit the request.

In some examples, the AI authorization service 136 can temporarily suspend AI-assisted approval pipelines associated with the failed credential pending administrative review, restrict or adjust model invocation permissions associated with the credential based on credential status, jurisdiction, or compliance policy, or dynamically tighten confidence thresholds for subsequent automated approvals associated with the invoking actor. In some examples, the AI authorization service 136 can flag the failed authentication attempt for review by an administrator or compliance officer and can route subsequent requests associated with the same credential to a credential-verified human reviewer with scope-limited permissions.

At 624, the AI authorization service 136 can record or otherwise update a governance record associated with the failed authentication or absence of the credential for AI invocation. For example, the AI authorization service 136 can record an identifier of the invoking actor or upstream component, an indication that the credential token was absent, invalid, expired, or revoked, a timestamp of the failed authentication attempt, an identifier of the requested AI model or analytic process that was blocked from execution, a jurisdictional or policy context associated with the request, a hash or cryptographic reference to the payload, and/or compliance metadata indicating the reason for the authentication failure. In some examples, the governance record further includes an indication of any post-failure actions taken by the AI authorization service 136, such as suspension of AI-assisted approval paths, restriction of model invocation permissions, or routing of subsequent requests to human review. In some examples, the governance record can be recorded in the on-chain ledger 140 of the blockchain network 116. In some examples, the governance record can be stored in the database 108, exported to a downstream system, or stored in any other suitable data store.

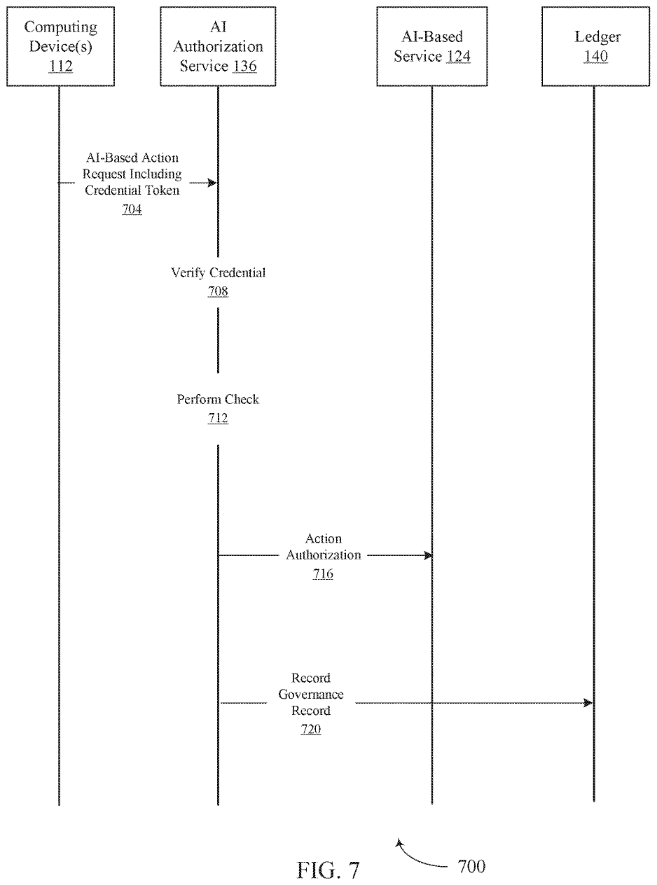

FIG. 7 is a swimlane diagram for an authentication workflow 700 in which a requested action is authorized, according to the present teachings. At 704, the AI authorization service 136 can receive a payload associated with a requested action. In some examples, the payload is received from the user computing device 112. In other examples, the payload is forwarded to the AI authorization service 136 by the AI-based service 124 responsive to a request output by the user computing device 112. The payload can include a credential associated with an upstream component that invokes the AI authorization service 136.

At 708, the AI authorization service 136 verifies that the credential included in the payload is valid. For example, the AI authorization service 136 can verify the cryptographic signature of the credential token to confirm authenticity and tamper resistance, validate that the credential token has not expired based on a validity period encoded therein, confirm that the credential token has not been revoked by querying a credential registry or revocation list, and determine that the role, department, site, facility, and/or jurisdictional attributes encoded in the credential token authorize invocation of the requested AI model for the particular action type.

In some examples, the AI authorization service 136 verifies the credential token against one or more credential validation policies that define which credential attributes are required for invocation of specific AI models or analytic processes. Responsive to successful verification of the credential token, the AI authorization service 136 determines that the invoking actor is authorized to invoke at least one AI model. In some examples, the AI authorization service 136 proceeds to invoke an AI model associated with the AI authorization service 136 to perform a check on the input data included in the payload. In this manner, any downstream AI model can be prevented from executing absent successful verification of the credential token, thereby ensuring that each AI-assisted decision is bound to a verified credential holder.

At 712, the AI authorization service 136 can perform a check on the data included in the authorization request received at 704. To perform the check, the AI authorization service 136 can analyze semantic consistency between structured data included in the input and unstructured data included in the input.

The AI authorization service 136 can compare a frequency or pattern of data included in request payloads submitted by a particular user role, department, site, and/or facility as identified by the credential token, against one or more dynamic behavioral baselines established for that user role, department, site, and/or facility.

The AI authorization service 136 can evaluate statistical abnormality of the input data relative to one or more historical baselines stored in the at least one database 108. Responsive to the check yielding a confidence measure or plausibility metric that meets or exceeds a governance threshold, the AI authorization service 136 can determine that the check is successful.

At 716, responsive to a successful check, the AI authorization service 136 can output at least one signal authorizing an execution of the requested action. The AI authorization service 136 can output the at least one signal directly to the AI-based service 124 and/or to the user computing device 112. The at least one signal can enable the AI-based service 124 to proceed with processing the request received at 704.

At 720, the AI authorization service 136 can record or otherwise update a governance record associated with the authorization of the action and/or associated with the verification of the credential (e.g., at 708). For example, the AI authorization service 136 can record the credential token associated with the invoking actor, an identifier and version of the AI model 144 used to perform the check, a validation status of the AI model 144, a confidence measure or plausibility metric output by the AI model 144, a governance decision indicating that the action was authorized to proceed, a timestamp corresponding to the check and/or the governance decision, a jurisdictional or policy context associated with the action, a cryptographic hash or reference to supporting explanation metadata, and/or an indicator that the action was authorized without human intervention. In some examples, the governance record further includes at least a portion of the first data from which PII has been scrubbed. As an example, the governance record can include one or more codes or a sanitized representation of a narrative. In some examples, the governance record can be recorded in the on-chain ledger 140 of the blockchain network 116. In some examples, the governance record can be stored in the database 108, exported to a downstream system, or stored in any other suitable data store.

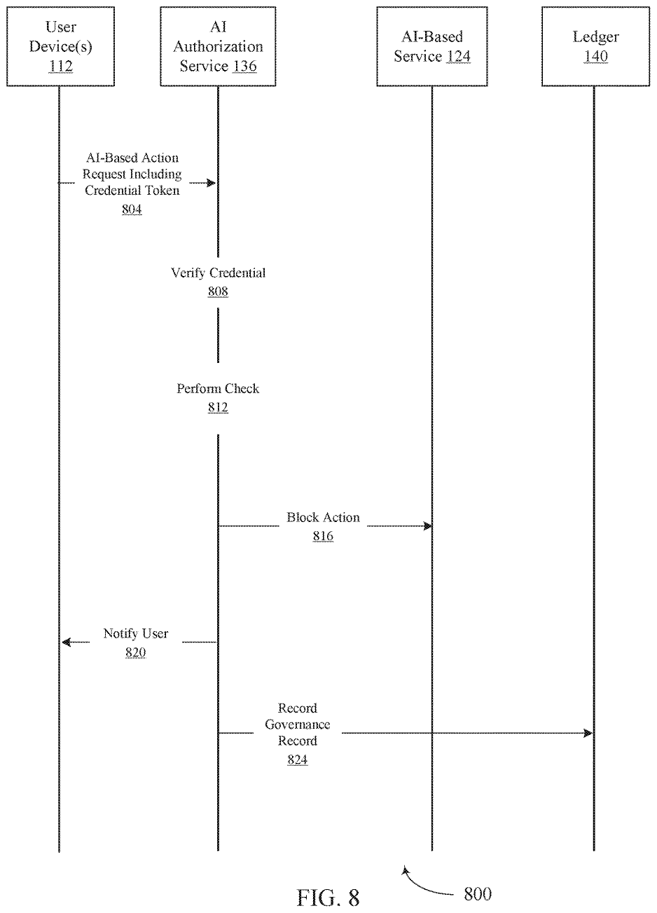

FIG. 8 is a swimlane diagram for an authentication workflow 800 in which a requested action is not authorized, according to the present teachings. At 804, the AI authorization service 136 can receive a payload associated with a requested action. In some examples, the payload is received from the user computing device 112. In other examples, the payload is forwarded to the AI authorization service 136 by the AI-based service 124 responsive to a request output by the user computing device 112. In addition to request-specific data, the payload can include a credential associated with an upstream component that invokes the AI authorization service 136.

At 808, the AI authorization service 136 verifies that the credential included in the payload is valid. For example, the AI authorization service 136 can verify the credential in a similar manner as described above with respect to step 708 of the workflow 700.

At 812, the AI authorization service 136 performs a check on the data included in the authorization request received at 804. The AI authorization service 136 may determine that the requested action is potentially fraudulent or otherwise not plausible responsive to detecting a semantic inconsistency between data included in the request payload.

The AI authorization service 136 may determine that the requested action is not plausible responsive to detecting a behavioral deviation in requests. As an example, a behavioral deviation can include an instance in which a clinic that historically bills a rare genetic disorder code for approximately five percent of patients recently submitting the same code for fifty percent of patients.

The AI authorization service 136 may determine that the requested action is potentially fraudulent responsive to identifying a statistical abnormality relative to one or more historical baselines. An example statistical abnormality can include a code frequency that deviates beyond a governance threshold when compared to peer-facility or peer baselines. In each case, the check can yield a confidence measure or plausibility metric that falls below one or more governance thresholds, causing the AI authorization service 136 to determine that the check is unsuccessful.

At 816, responsive to the unsuccessful check, the AI authorization service 136 can output at least one signal at least temporarily blocking execution of the requested action. The AI authorization service 136 can output the at least one signal to the service 124 and/or the at least one user computing device 112.

At 820, the AI authorization service 136 can output at least one signal to the user computing device 112 and/or to an administrative computing device, notifying the user and/or administrator of the blocked action. For example, the AI authorization service 136 may flag, to an administrator, the user that requested the action and a reason for the denial.

In some examples, the AI authorization service 136 outputs a request to the user computing device 112 that submitted the request and/or to an administrative computing device for human review of the request. For example, the AI authorization service 136 can request human review when the plausibility metric falls below a first governance threshold but meets or exceeds a second, lower governance threshold, indicating that the action is neither clearly plausible nor clearly fraudulent.

Human review may be requested when the AI authorization service 136 detects a behavioral deviation that persists over multiple actions associated with a particular credential, when a secondary credential attestation is required due to a role-based or facility-bound policy constraint, or when the confidence or credential integrity associated with the action falls below a governance threshold.

Human review may be requested for actions involving rare or complex request payloads. As an example, human review may be requested for rare or complex clinical cases in which automated plausibility assessment may be insufficient to make a reliable governance determination.

Responsive to receiving an approval of the request from the human review, the AI authorization service 136 can output a signal to enable execution of the requested action. In some examples, the approval includes a modification to structured and/or unstructured data included in the request payload.

At 824, the AI authorization service 136 can record or otherwise update a governance record associated with the denial of the action, the human review of the action, a modification to the action, and/or the verification of the credential. For example, the AI authorization service 136 can record the credential token associated with the invoking actor, an identifier and version of an AI model that performed the check, a confidence measure or plausibility metric resulting from the check, a governance decision indicating that the action was blocked or routed for human review, a timestamp of the governance event, one or more reason codes and explanation metadata describing the basis for the unsuccessful check (e.g., a detected semantic inconsistency, behavioral deviation, or statistical abnormality), model-trace identifiers linking the governance outcome to the specific analytic execution, an identifier and version of the requested AI model 132 authorized to perform an operation, jurisdictional or policy context applicable to the action, and, where human review was performed, a credential-signed reviewer action (e.g., approval, modification, or denial), an indicator of the reviewer's credential identifier and role, or a combination thereof. In some examples, the governance record further includes a cryptographic hash or reference to supporting explanation data stored off-chain, enabling post hoc attribution of responsibility for the action without exposing protected information. In some examples, the governance record can be recorded in the on-chain ledger 140 of the blockchain network 116. In some examples, the governance record can be stored in the database 108, exported to a downstream system, or stored in any other suitable data store.

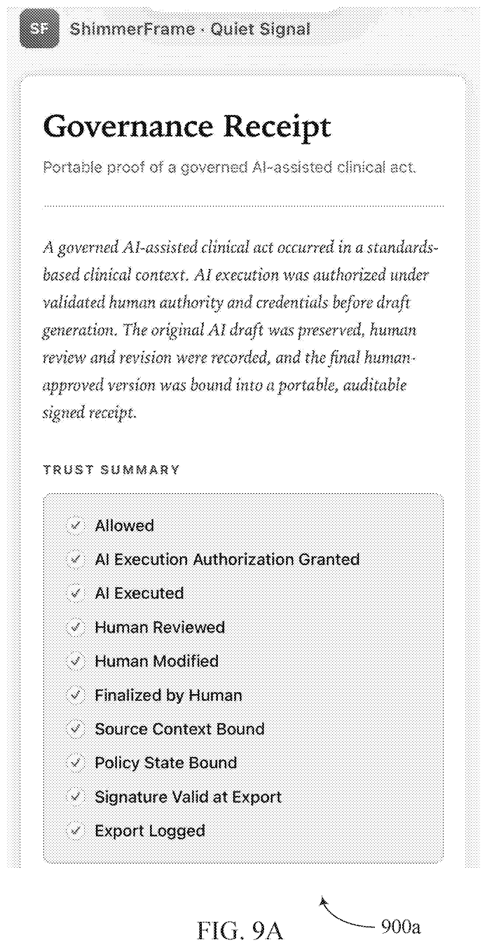

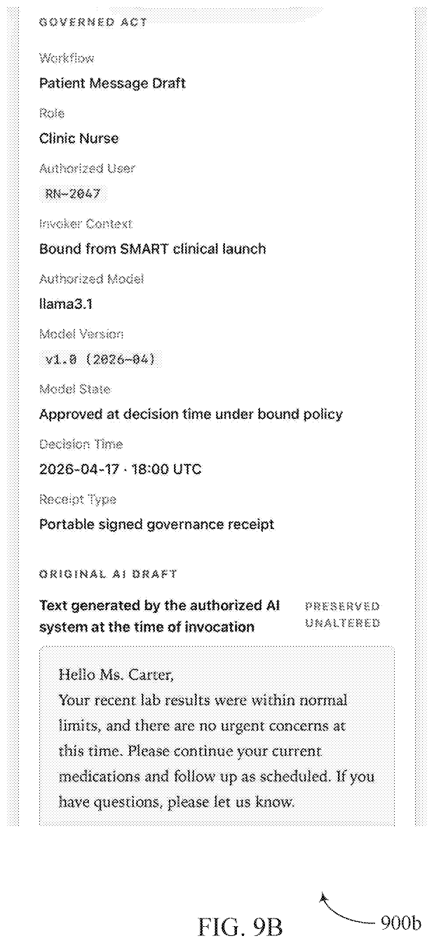

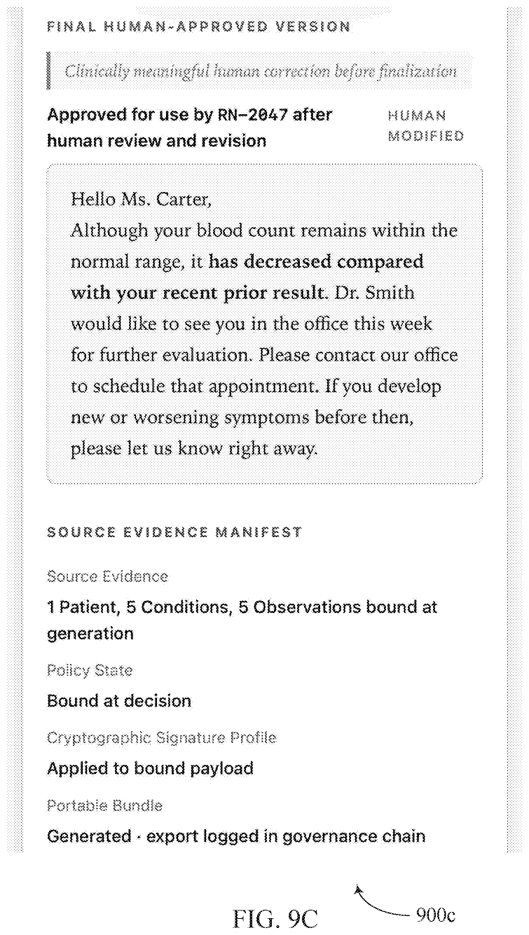

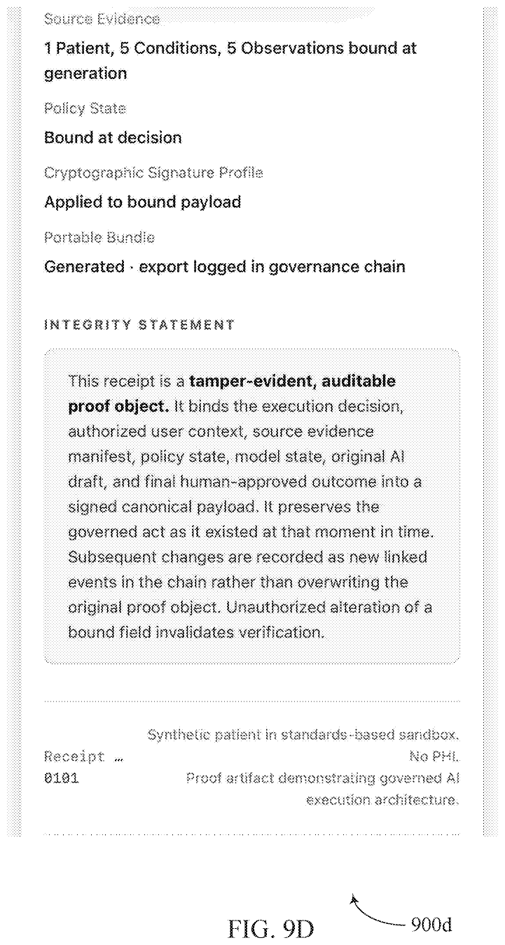

FIG. 9A illustrates a portion 900a of an example governance record or governance receipt that may be generated in conjunction with the computing system 100 of FIG. 1. The portion 900a can include a receipt header identifying the governance receipt as portable proof of a governed AI-assisted act. The portion 900a can include a description field indicating that a governed AI-assisted act occurred in a standards-based context, that AI execution was authorized under validated human authority and credentials before output generation, that an original AI draft was preserved, that human review and revision were recorded, and that a final human-approved version was bound into a portable, auditable signed receipt.

The portion 900a can include a trust summary section comprising a plurality of trust indicator fields. Each trust indicator field can indicate a status of a respective governance condition associated with the governed act. For example, the trust indicator fields can include an authorization status indicator (e.g., “Allowed”), an AI execution authorization status indicator (e.g., “AI Execution Authorization Granted”), an AI execution status indicator (e.g., “AI Executed”), a human review status indicator (e.g., “Human Reviewed”), a human modification status indicator (e.g., “Human Modified”), a human finalization status indicator (e.g., “Finalized by Human”), a source context binding status indicator (e.g., “Source Context Bound”), a policy state binding status indicator (e.g., “Policy State Bound”), a signature validity status indicator (e.g., “Signature Valid at Export”), an export logging status indicator (e.g., “Export Logged”), or a combination thereof. Each trust indicator field can be populated with a value indicating whether the corresponding governance condition was satisfied for the governed act. In the example of FIG. 9A, each trust indicator field is shown as satisfied, indicating that the governed act was authorized, executed, reviewed, modified, and finalized by a human, that source context and policy state were bound, that the cryptographic signature was valid at export, and that the export event was logged. The governance receipt can include more or fewer data fields than those shown in FIG. 9A.

FIG. 9B illustrates a portion 900b of an example governance record or governance receipt that may be generated in conjunction with the computing system 100 of FIG. 1. The portion 900b can include a governed act section comprising metadata fields associated with the governed AI-assisted act. For example, the governed act section can include a workflow field identifying a type of workflow associated with the governed act (e.g., “Patient Message Draft”), a role field identifying a role of the authorized user (e.g., “Clinic Nurse”), an authorized user field identifying the credential holder who authorized the AI execution (e.g., “RN-2047”), an invoker context field indicating a context from which the invocation was initiated (e.g., “Bound from SMART clinical launch”), an authorized model field identifying the AI model that was authorized to execute (e.g., “llama3.1”), a model version field identifying a version of the authorized AI model (e.g., “v1.0 (2026-04)”), a model state field indicating a policy status of the AI model at the time of the governance decision (e.g., “Approved at decision time under bound policy”), a decision time field indicating a timestamp corresponding to the governance decision (e.g., “2026-Apr.-17·18:00 UTC”), a receipt type field identifying a type of the governance receipt (e.g., “Portable signed governance receipt”), or a combination thereof. The portion 900b can include an original AI draft section that preserves the text generated by the authorized AI model at the time of invocation.

The original AI draft section can include a preservation status indicator (e.g., “Preserved Unaltered”) indicating that the original AI-generated output has not been modified. In the example of FIG. 9B, the original AI draft section includes example text of a patient message generated by the AI model. By preserving the original AI draft in the governance receipt, the AI authorization service 136 can enable downstream comparison between the machine-originated output and a final human-approved version, thereby supporting provenance tracking and authorship attribution. The governance receipt can include more or fewer data fields than those shown in FIG. 9B.

FIG. 9C illustrates a portion 900c of an example governance record or governance receipt that may be generated in conjunction with the computing system 100 of FIG. 1. The portion 900c can include a final human-approved version section that records the output as approved by a credential-verified human reviewer after human review and revision. The final human-approved version section can include a modification status indicator (e.g., “Human Modified”) indicating that the credential-verified human reviewer made clinically meaningful corrections to the original AI draft prior to finalization. The final human-approved version section can include an approval attribution field identifying the authorized user who approved the final version (e.g., “Approved for use by RN-2047 after human review and revision”).

In the example of FIG. 9C, the final human-approved version section includes example text of a revised patient message that differs from the original AI draft shown in FIG. 9B, reflecting corrections and additions made by the human reviewer. In this manner, the governance receipt can preserve a distinction between the machine-originated output and the human-reviewed, corrected, and finalized outcome, enabling downstream systems, auditors, and/or regulators to evaluate the nature and extent of human intervention in the governed act. The portion 900c can include a source evidence manifest section comprising metadata fields that describe the source data, policy state, cryptographic signature profile, and export status associated with the governed act. For example, the source evidence manifest section can include a source evidence field identifying a type and quantity of source data bound at the time of AI output generation (e.g., “1 Patient, 5 Conditions, 5 Observations bound at generation”), a policy state field indicating that the governing policy was bound at the time of the governance decision (e.g., “Bound at decision”), a cryptographic signature profile field indicating that a cryptographic signature was applied to the bound payload (e.g., “Applied to bound payload”), a portable bundle field indicating that a portable bundle was generated and that the export event was logged in a governance chain (e.g., “Generated·export logged in governance chain”), or a combination thereof. The governance receipt can include more or fewer data fields than those shown in FIG. 9C.

FIG. 9D illustrates a portion 900d of an example governance record or governance receipt that may be generated in conjunction with the computing system 100 of FIG. 1. The portion 900d can include an integrity statement section that describes the tamper-evident and auditable properties of the governance receipt. For example, the integrity statement section can indicate that the governance receipt is a tamper-evident, auditable proof object that binds the execution decision, authorized user context, source evidence manifest, policy state, model state, original AI draft, and final human-approved outcome into a signed canonical payload. The integrity statement section can indicate that the governance receipt preserves the governed act as the governed act existed at the time of execution, that subsequent changes are recorded as new linked events in a governance chain rather than overwriting the original proof object, and that unauthorized alteration of a bound field invalidates verification. In this manner, the integrity statement section can communicate to downstream recipients, auditors, and/or regulators that the governance receipt is designed to function as an immutable record of the governed act, with any subsequent modifications recorded as linked governance events rather than as modifications to the original receipt.

The portion 900d can include a data provenance indicator. For example, the data provenance indicator can indicate whether the governed act was performed using synthetic data, production data, or other data categories, and can indicate whether the governance receipt contains protected information. In the example of FIG. 9D, the data provenance indicator indicates that the governed act involved a synthetic patient in a standards-based sandbox and that no protected health information (PHI) is present. The portion 900d can include a receipt identifier field and a proof artifact designation indicating that the governance receipt functions as a proof artifact demonstrating governed AI execution architecture. The governance receipt can include more or fewer data fields than those shown in FIG. 9D.

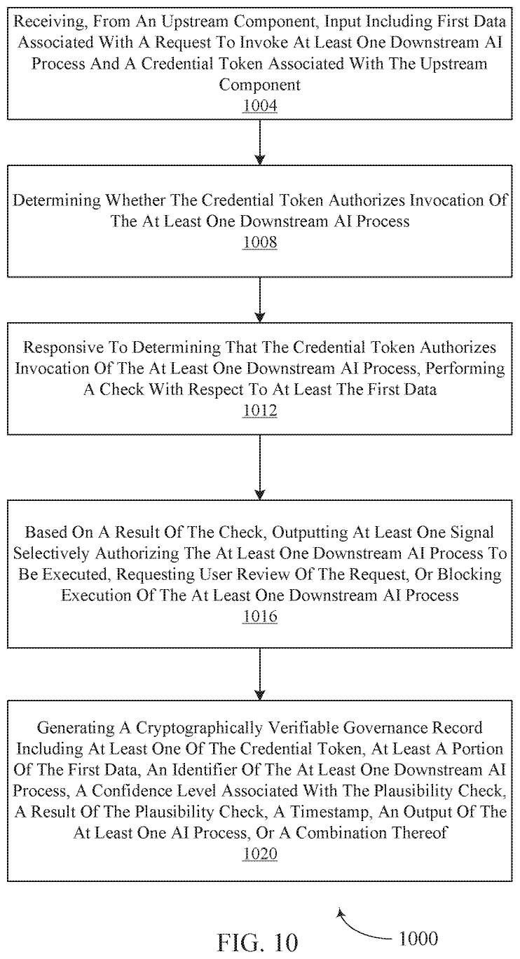

FIG. 10 is a flowchart of a process 1000 for performing authentication of AI processes, according to the present teachings. Although the process steps are described with reference to the systems and processes of FIGS. 1-9, persons skilled in the art will understand that any system adapted to implement the process steps, in any order, falls within the scope of the present invention. In that regard, operations of the process 1000 can be performed by, for example, the system computing device 104 (e.g., by the AI authorization service 136) in conjunction with other components of the computing system 100.

At step 1004, the process 1000 can include receiving, from an upstream component, input including first data associated with a request to invoke at least one downstream AI process and a credential token associated with the upstream component. For example, the AI authorization service 136 can receive, from the user computing device 112, input including first data associated with a request to invoke the at least one AI model 132 of the AI-based service 124. In instances where the first data includes unstructured data, the process 1000 can include processing the first data to normalize and structure the first data. The credential token can be a timestamped cryptographic token indicative of a particular user account. Alternatively or in addition, the cryptographic token can be indicative of a particular facility and/or a particular user role.

At step 1008, the process 1000 can include determining whether the credential token authorizes invocation of the at least one downstream AI process. For example, the AI authorization service 136 can determine whether the credential token authorizes invocation of the AI model 132.

At step 1012, the process 1000 can include, responsive to determining that the credential token authorizes invocation of the at least one downstream AI process, performing a check with respect to at least the first data. The at least one downstream AI process may include a single-model AI process, a multi-agent AI process, a cascading agent invocation, an agent-created subordinate agent process, a tool-assisted generation process, and/or the like.

In some examples, the process 1000 includes blocking invocation of the at least one AI model responsive to determining that the credential token does not authorize invocation of the AI process. In some examples, the check includes analyzing semantic consistency of the first data, behavioral deviation associated with the first data, statistical abnormality of the first data relative to at least one historical baseline, or a combination thereof. Alternatively or in addition, the check can include verifying an identity of a user requesting execution of the downstream AI process based at least in part on the credential token.

In some examples, the first data includes a structured data item, and the check includes verifying that a frequency at which the structured data item is received over a predetermined period of time is within an expected range. The expected range can be associated with a particular user and/or a particular facility identified based on, for example, the credential token. Alternatively or in addition, the expected range can be associated with a plurality of facilities. In this manner, the AI authorization service 136 can detect and learn new fraud patterns, such as a rare code spreading through several states, without exposing patient or clinician data.

In some examples, the first data includes an unstructured data item, and the check includes verifying that the first data is semantically consistent with data included in previously received requests associated with the credential token. For example, the AI authorization service 136 can verify that a code is semantically consistent with a natural language description of the claim to be processed.

At step 1016, the process 1000 can include, based on a result of the check, outputting at least one signal selectively authorizing the at least one downstream AI process to be executed, requesting user review of the request, or blocking execution of the at least one downstream AI process. The request for user review of the request can include a request for additional data or additional context related to the request. In some examples, outputting at least one signal requesting user review of the request or blocking execution of the at least one downstream AI process is performed responsive to a plausibility metric being below a threshold. In some examples, outputting at least one signal authorizing the at least one downstream AI process to be executed is performed responsive to a plausibility metric meeting or exceeding a threshold.

At step 1020, the process 1000 can include generating a cryptographically verifiable governance record including at least one of the credential token, at least a portion of the first data, an identifier of the at least one downstream AI process, a confidence level associated with the check, a result of the check, a timestamp, a result of the invocation of the at least one AI process, or a combination thereof. Data included in the governance record can be cryptographically encoded. In some examples, recording the governance record includes detecting and scrubbing PII associated from the first data.

The cryptographically verifiable record may be cryptographically signed. In some examples, the process 1000 includes exporting the cryptographically verifiable record. In such examples, the record may be independently verifiable without access to the originating infrastructure. In some examples, the cryptographically verifiable record is recorded in an on-chain ledger, such as the on-chain ledger 140 described with reference to FIG. 1.

In some examples, the process 1000 includes destroying the credential token responsive to recording the governance record.

In some examples, the process 1000 includes, responsive to outputting at least one signal requesting user review of the request, receiving a response indicating one of an approval of the request, a correction of the first data, or a denial of the request. In such examples, the process 1000 can include training a machine learning model that performs the check based on the response. In some examples, the process 1000 further includes updating the governance record with at least a portion of the response.

As AI becomes embedded in operational and regulatory environments, organizations face growing requirements to demonstrate who authorized AI activity, under what credentials, under what policies, and what model produced a given output. Regulatory frameworks and technical standards, such as the National Institute of Standards and Technology (NIST) AI Risk Management Framework, the European Union AI Act, standards work such as the Internet Engineering Task Force (IETF) Supply Chain Integrity, Transparency, and Trust (SCITT) framework, and healthcare-specific guidance from bodies such as the Office of the National Coordinator for Health Information Technology (ONC), the Food and Drug Administration (FDA), Health Level 7 (HL7), and the Coalition for Health AI (CHAI), increasingly emphasize traceability, accountability, human oversight, and governance of AI systems. These developments reflect a broader trend toward infrastructure capable of authorizing AI activity and producing independently verifiable records of that activity. In regulated industries such as financial services, government, and healthcare, the limitations of conventional approaches can result in unauthorized AI activity, fragmented accountability, and an inability to demonstrate compliance with applicable governance requirements.

By way of example, the AI-based service 124 can include a healthcare payment service designed to process healthcare claims initiated by clinicians, administrators, or other users associated with a healthcare network. In a similar example, the AI-based service 124 can include a facility-specific service or a healthcare provider-specific service. The AI-based service 124 can include any type of AI-based service that processes requests in a domain subject to governance, compliance, or regulatory requirements. For example, the AI-based service 124 can include a financial action processing service designed to process loan origination requests, credit underwriting decisions, anti-money laundering assessments, or securities trading operations in a banking or financial services environment. As another example, the AI-based service 124 can include a government benefits adjudication service, an insurance claims processing service, a supply chain verification service, a legal document analysis service, or other AI-based services deployed in industries where regulatory compliance, auditability, and credential-based authorization of AI-assisted decisions are required.

In an example healthcare use case, a user role can include a physician, coding specialist, administrator, or the like. In some examples, the AI authorization service 136 includes a standards-agnostic data ingestion layer that accepts structured and unstructured data. In an example healthcare use case, the standards-agnostic data ingestion layer can ingest clinical and claims data through, for example, Fast Healthcare Interoperability Resources (FHIR), HL7, and/or clearinghouse interfaces. The AI authorization service 136 can normalize inbound data through, for example, credential-verified gateways using tokenized identities and role-based access controls. This ingestion layer can include data-quality scoring and semantic-version tracking (e.g., in collaboration with data stored in the at least one database 108) to maintain vocabulary currency as coding standards, such as International Classification of Diseases (ICD), Current Procedural Terminology (CPT), and Systematized Nomenclature of Medicine (SNOMED) evolve. In an example healthcare use case, a payload can include healthcare-related input data such as structured billing codes (e.g., ICD-10, CPT, or SNOMED codes), clinical narrative text or documentation associated with the requested action, patient demographic identifiers, facility identifiers, claim descriptions, procedure descriptions, diagnosis information, and/or other clinical or financial data associated with the action. In some examples, the payload includes both structured data, such as standardized billing codes and claim metadata, and unstructured data, such as free-text clinical notes or supporting documentation. The payload can be received via one or more healthcare interoperability interfaces, such as FHIR, HL7, or clearinghouse interfaces, and can be normalized and quality-scored by the AI authorization service 136 upon ingestion.

Following the example healthcare use case, the AI model 144 can compare billing codes included in the input data against clinical narrative text to verify that the codes are semantically supported by the clinical documentation. As another example, the AI model 144 can compare a frequency or pattern of billing codes submitted by a particular clinician or facility against dynamic behavioral baselines established for that clinician or facility, and flag deviations that exceed governance thresholds. For example, the AI authorization service 136 can analyze semantic consistency between billing codes included in the healthcare transaction data and clinical narrative text accompanying the transaction to verify that the codes are supported by the clinical documentation. As an example in a healthcare use case, a billing code indicating a knee replacement procedure accompanied by clinical documentation describing a sprained ankle can be flagged as inconsistent. As another example, the AI authorization service 136 can further compare a frequency or pattern of billing codes submitted by a particular clinician or facility, as identified by the credential token, against one or more dynamic behavioral baselines established for that clinician or facility.

As an example healthcare use case, the AI-based service 124 can process a billing claim for payment adjudication, submit the claim to a downstream clearinghouse or payer system, authorize disbursement of payment to a healthcare provider, or proceed with other downstream clinical, billing, or payment actions associated with the healthcare request. For example, the AI-based service 124 can process a medical billing claim including one or more billing codes, such as ICD-10 diagnosis codes or CPT procedure codes, for reimbursement by a payer. As an example, the AI authorization service 136 can determine that a billing code for a rare genetic disorder submitted by a particular clinic is consistent with the historical billing frequency for that clinic, that the clinical narrative text semantically supports the submitted billing code, and that no statistical anomalies are detected relative to peer-facility baselines. As an example in a healthcare use case, an approval received from a human reviewer can include a modified billing code, modified description, or the like.

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims.

Moreover, in this document, relational terms such as first and second, top and bottom, and the like may be used to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application-specific integrated circuits (ASICs), in which each function or some combinations of certain of the functions are implemented as custom logic. Of course, a combination of the two approaches could be used.

Moreover, an example can be implemented as a computer-readable storage medium having computer-readable code stored thereon for programming a computer (e.g., comprising a processor) to perform a method as described and claimed herein. Any suitable computer-usable or computer-readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), and a Flash memory. In the context of this document, a computer-usable or computer-readable medium may be any medium that can contain, store, communicate, propagate, or transport the program for use by or in connection with the instruction execution system, apparatus, or device.

A device or structure that is “configured” in a certain way is configured in at least that way, but may also be configured in ways that are not listed.

The terms “coupled,” “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal, or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A process comprising:
receiving, from an upstream component, input including first data associated with a request to invoke at least one downstream artificial intelligence (AI) process and a credential token associated with the upstream component;
determining whether the credential token authorizes invocation of the at least one downstream AI process;
responsive to determining that the credential token authorizes invocation of the at least one downstream AI process, performing a check with respect to at least the first data;
based on a result of the check, outputting at least one signal selectively authorizing the at least one downstream AI process to be executed, requesting user review of the request, or blocking execution of the at least one downstream AI process; and
generating a cryptographically verifiable governance record including at least one of the credential token, at least a portion of the first data, an identifier of the at least one downstream AI process, a confidence level associated with the check, a result of the check, a timestamp, an output of the at least one AI process, or a combination thereof.

2. The process of claim 1, further comprising:
responsive to determining that the credential token does not authorize invocation of the AI process, blocking an invocation of the at least one AI process.

3. The process of claim 1, wherein outputting at least one signal requesting user review of the request or blocking execution of the at least one downstream AI process is performed responsive to a plausibility metric being below a threshold.

4. The process of claim 1, wherein outputting at least one signal authorizing the at least one downstream AI process to be executed is performed responsive to a plausibility metric meeting or exceeding a threshold.

5. The process of claim 1, wherein the check includes analyzing semantic consistency of the first data, behavioral deviation associated with the first data, statistical abnormality of the first data relative to at least one historical baseline, or a combination thereof.

6. The process of claim 1, wherein data included in the governance record is cryptographically encoded.

7. The process of claim 1, wherein recording the governance record includes detecting and scrubbing personally identifying information (PII) from the first data.

8. The process of claim 1, wherein the check includes a verification of an identity of a user requesting the at least one downstream AI process based at least in part on the credential token.

9. The process of claim 1, wherein the first data includes a structured data item, and the check includes verifying that a frequency at which the structured data item is received over a predetermined period of time is within an expected range.

10. The process of claim 9, wherein the expected range is associated with a particular user and/or a particular facility.

11. The process of claim 1, wherein the first data includes an unstructured data item, and the check includes verifying that the first data is semantically consistent with data included in previously received requests associated with the credential token.

12. The process of claim 1, wherein the check is performed using a machine learning model, and the process further comprises:
responsive to outputting at least one signal requesting user review of the request, receiving a response indicating one of an approval of the request, a correction of the first data, or a denial of the request; and
training the machine learning model based on the response.

13. The process of claim 12, further comprising:
updating the governance record with at least a portion of the response.

14. The process of claim 1, wherein the credential token is a timestamped cryptographic token indicative of a particular user account.

15. The process of claim 14, wherein the cryptographic token is further indicative of a particular location and/or a particular user role.

16. The process of claim 14, further comprising destroying the credential token responsive to recording the governance record.

17. The process of claim 1, wherein the at least one downstream AI process comprises one or more of a single-model AI process, a multi-agent AI process, a cascading agent invocation, an agent-created subordinate agent process, or a tool-assisted generation process.

18. A computing system comprising:
a memory storing instructions; and
at least one processor designed to execute the instructions to cause the computing system to:
receive, from an upstream component, input including first data associated with a request to invoke at least one downstream artificial intelligence (AI) process and a credential token associated with the upstream component;
determine whether the credential token authorizes invocation of the at least one downstream AI process;
responsive to determining that the credential token authorizes invocation of the at least one downstream AI process, perform a check with respect to at least the first data;
based on a result of the check, output at least one signal selectively authorizing the at least one downstream AI process to be executed, requesting user review of the request, or blocking execution of the at least one downstream AI process; and
record a cryptographically verifiable governance record associated with the request, the governance record including at least one of the credential token, at least a portion of the first data, an identifier of the at least one downstream AI process, a confidence level associated with the check, a result of the check, a timestamp, an output of the at least one AI process, or a combination thereof.

19. The computing system of claim 18, wherein the instructions further cause the computing system to:
responsive to determining that the credential token does not authorize invocation of the AI process, block an invocation of the at least one AI process.

20. A non-transitory computer-readable medium storing instructions that, when executed by at least one processor, cause the at least one processor to perform a set of operations comprising:
receiving, from an upstream component, input including first data associated with a request to invoke at least one downstream artificial intelligence (AI) process and a credential token associated with the upstream component;
determining whether the credential token authorizes invocation of the at least one downstream AI process;
responsive to determining that the credential token authorizes invocation of the at least one downstream AI process, performing a check with respect to at least the first data;
based on a result of the check, outputting at least one signal selectively authorizing the at least one downstream AI process to be executed, requesting user review of the request, or blocking execution of the at least one downstream AI process;
generating a cryptographically signed governance record associated with the request, the governance record including at least one of the credential token, at least a portion of the first data, an identifier of the at least one downstream AI process, a confidence level associated with the check, a result of the check, a timestamp, an output of the at least one AI process, or a combination thereof; and
exporting the cryptographically signed governance record.
